(19) United States
(12) Patent Application Publication
(10) Pub. No.: US 2010/0211638 A1
(43) Pub. Date: Aug. 19, 2010

(54) METHOD AND DEVICE FOR CREATING COMPUTER APPLICATIONS

(75) Inventor: Marc Rougier, Labege (FR)

Correspondence Address: YOUNG & THOMPSON, 209 Madison Street, Suite 500, Alexandria, VA, 22314, US

(73) Assignee: GOOJET, Labege (FR)

(21) Appl. No.: 12/670,931

(22) PCT Filed: Jul. 25, 2008
(86) PCT No.: PCT/FR08/01126

§ 371 Date: May 4, 2010

(30) Foreign Application Priority Data
Jul. 27, 2007 (FR) 0705495
Aug. 1, 2007 (FR) 0705636
Apr. 14, 2008 (FR) 0802064
Apr. 21, 2008 (FR) 0802222
Apr. 30, 2008 (FR) 0802459

(51) Int. Cl. G06F 9/44; G06F 3/14; G06F 17/00; G06F 15/173; G06F 15/16; G06F 9/45

(52) U.S. Cl. 709/205; 717/106; 715/205; 715/234; 709/238; 717/148

(57) ABSTRACT

The invention relates to a method for creating computer applications, including the following steps: receipt of a message that has a content; determination of a computer application type that can be associated with said content; and parameterisation of a generic application of the pre-determined application type with the content in order to form the computer application. In particular embodiments of the invention, during the step comprising the determination of a computer application type, the computer application type depends on: the identity of the message sender, at least one message attachment and/or key words contained in the content of the message.

This invention concerns a process and a device for creating computer applications.

More and more, mobile telephones and other terminals make it possible to use computer applications that utilize optimized ergonomics and efficient user interfaces. However, when one wants to communicate with a third-party, one rarely has the skills and the time to create such an application. Communication between people therefore remains limited to messages, generally voice or text, with the limitations that this implies.

The aim of the present invention is to remedy these drawbacks.

To this end, according to a first aspect, the present invention envisages a process for creating computer applications, that comprises:
a step of receiving a message that has a content,
a step of determining a type of computer application likely to be associated to said content and
a step of parameterizing a generic application of the application type determined with said content to constitute said computer application.

Thanks to these provisions, computer applications can be constituted by sending a simple message, for example an electronic mail or a short message.

According to particular features, during the step determining a type of computer application, the type of computer application depends on the identity of the sender of said message.

For example, several types of computer application are associated to each sender.

According to particular features, during the step determining a type of computer application, the type of computer application depends on at least one attachment of said message.

According to particular features, during the step determining a type of computer application, the type of computer application depends on key words included in the content of said message.

For example, photos attached to the message become a photo album application with the electronic mail's subject as the title, a future date and time and a place become a calendar application with an event to be noted with the meeting place as the title, a selection list in a message intended for several recipients of the same message becomes a voting application.

In the preceding examples, the message was solely considered as an electronic mail, but the following media can also be taken into account:
short message (“SMS”),
multimedia message (“MMS”),
instant message (“IM”),
telephone message (electronic representation of a telephone call: sound file),
fax or
address of an electronic page on the web (“URL”).

In fact, all electronic sources (textual, sound, images whatever the formats with syndication or not of the sources (text+image, only text, etc)) are input sources for creating a full-featured application using some or all of the content.

In most cases, identifying the user may/must be required in order to allow this new application to be added to his/her account. In most of the media sources proposed above, there are means of automatically identifying users who are the sender and recipient (or recipients) without adding this information to the rest of the content: caller number, identifier or user name, etc.

According to a second aspect, the present invention envisages a device for creating computer applications, that comprises:
a means of receiving a message that has a content,
a means of determining a type of computer application likely to be associated to said content and
a means of parameterizing a generic application of the application type determined with said content to constitute said computer application.

This invention also concerns a process and a device for creating, organizing, delivering, using and/or accessing services.

There are many systems aiming to allow services to be created, organized, delivered, used and/or accessed. However, these systems are not suited to communicating mobile terminals and are, as a result, not used very much.

Currently, three approaches co-exist for accessing Internet services via a communicating mobile terminal:
applications embedded on the telephones, dedicated to a given single remote service, which communicate with said service via a proprietary protocol in a model known as “thick client”;
“native navigators” embedded in telephones, which allow Internet sites to be accessed via their wml (acronym for “Wireless Markup Language”), WAP (acronym for “Wireless Application Protocol”), html (acronym for “HyperText Markup Language”) or xhtml (acronym for “Extensible HyperText Markup Language”) representation and
“specialized navigators”, conceptually similar to native navigators in that they are not dedicated to a single service and in that on the telephone they interpret a representation in markup language of the remote service or services.

The present invention concerns the third category more particularly.

The first category is what is known as a “closed” and static system, not authorizing third parties to develop content or compatible services, and obliging the user to install and learn as many dedicated applications as the services he/she wants to use. In contrast, the system that is the subject of this invention is open: the mobile client can interpret an unpredefined number of new services, without requiring changes or new installations on the client side.

The second category is open but is not suited to mobility: it is content to reduce the display format to the screen size. Moreover, these native navigators do not allow an optimized communications protocol manager to be implemented, such as for instance intelligent management of the cache and “prefetch” (for preloads or early downloads) according to the semantics of the services and the user's behavioral profile. Lastly, these native navigators cannot use the telephone's basic functions, such the telephone call or sending SMS (acronym for “Short Message System”).

This invention offers the second category's openness and generic nature but in addition, by “filtering”, allows a web service's information to be extracted and presented in a specific way for mobility. It also allows optimized and pertinent management of the protocol based on the services and the user, and an integrated use of the telephone's basic functions (calls, SMS).

The third category, to which the subject of this invention belongs, includes several existing solutions. However, compared to these solutions, the present invention presents the following advantages:
a data representation model that allows a recursive tree-structure organization of the services space in which the new system allows navigation; this tree structure is evolutive; users can navigate step by step in the space thus organized, beginning by accessing their own personal space, as they have defined it for themselves, then by steps accessing the public portions (or those for which they have been given an explicit individual access right) of other users' spaces. In this way users benefit from navigation in a proper space, organized according to their own needs, but not closed and not restricted to their “own area”; in addition, they benefit from a navigator that moves from local services to remote services in a transparent way: this is the concept of the extended menu (local+remote), which enables mobile applications to be distributed and managed remotely;
an opening up of the platform that allows third-parties to create, distribute and promote new services in the managed services space, without having to develop code;
a social aspect in the platform, which measures and records all the uses of all the services by all the users and deduces profiles from this; and which also allows the platform to be used for exchanging services and data between users;
finally, a dual mode aspect: for each service defined on this system there are two corresponding representations, one for each access mode, mobile telephone or computer; the representation is optimized for the access mode, not only in terms of formatting (taking screen sizes into account) but above all in semantic terms (in mobility situations only the important information is transmitted to the mobile telephone, while the representation on the computer is semantically and functionally enriched).

This invention aims to present its advantages and therefore to remedy the drawbacks corresponding to the prior art.

For this purpose, according to a third aspect, this invention envisages a process for creating, organizing, delivering, using and/or accessing applications, characterized in that it comprises a step of matching applications with a tree-structure, at least two said applications coming from the web, and in an iterative way:
a step of displaying, on a communicating mobile terminal's screen, representations of nodes or descendant leaves of the same node or the root of the tree-structure,
a step of selecting, on said mobile terminal, one of said displayed representations,
a step of communicating, by the mobile terminal to the server, an indication of the node or leaf corresponding to the representation selected,
if a node had been selected, a step of supplying, by the server to the mobile terminal, identifiers of the nodes or descendant leaves of the node selected and an iteration of the selection, communication and supply steps and
if an application from the web is selected, a step of initiating this application.

In this way this invention responds to the needs of mobility, which requires an intelligent extraction of a sub-set of data, within a complete full-featured site, that are relevant in mobility situations.

According to particular features, if the number of representations of nodes or descendant leaves of a single node or the root of the tree-structure is less than or equal to nine, during the display step, representations are displayed on three lines of three available positions and, during the selection step, a keypad is utilized having at least three lines of at least three keys corresponding, by homothety, to each position of the nine keys allowing the selection of the representation in the corresponding position.

Selecting a representation is therefore intuitive and quick.

According to particular features, if the number of representations of nodes or descendant leaves of a single node or the root greater than nine, during the display step, a number less than or equal to seven representations of nodes or leaves are displayed and at least two representations of movements allowing the scrolling of the representations of nodes or leaves displayed.

According to particular features, during the selection step a line of three additional keys is utilized in addition allowing selection:
with the help of text superposed on the representations, these representations taking a graphic form,
of accessing the home page, i.e. the nodes and leaves linked to the tree-structure's root, and
of accessing the representations displayed before the last node or leaf selection step.

Thus having, at each level of the tree-structure, at most a number of nodes or leaves corresponding to the number of keys of a mobile telephone's keypad, allows the user to navigate by a single press on a key associated to a node or a leaf and go to the computer application they are interested in.

According to particular features, during the selection step, pressing for more than a pre-defined time causes a contextual menu to be displayed comprising at least help in using the corresponding node or leaf.

According to particular features, before said iterations, in response to the initial navigation request the server supplies identifiers of nodes or leaves, the first selection step being carried out on the nodes or leaves supplied by the server in response to the initial navigation request.

According to particular features, before said iterations, the mobile displays identifiers of nodes or leaves stored in memory by said mobile.

According to particular features, at least one said application is such that, once initiated, at least one new iteration is carried out.

Said application therefore benefits from the same ease of navigation as that linked to the tree-structure.

According to particular features, during each supply step the server supplies, in advance, at least the matrices of nodes or leaves to be displayed after each possible selection.

Thanks to these provisions, at least one tree-structure level is loaded in advance and time is gained for navigation.

According to particular features, during the step matching applications with a tree-structure, services are matched with said tree-structure and each leaf corresponds to the content of a service or application.

According to particular features, during the matching step, page hypertext links are matched with nodes of the tree-structure.

According to particular features, during the matching step, contents of pages are matched with leaves of the tree-structure.

These features make it possible to not wait until the pages are loaded before selecting a link present on that page. These features work much better if the site with these pages is a companion site adding, in the pages, elements allowing a graphic representation of each link to be realized.

According to particular features, the process as described in brief above comprises a step of accessing the server from a second terminal, a step of displaying, on a portion of the page displayed on said second terminal's screen, representations such as they would appear during iterations, on a screen of the mobile terminal.

Simulating access by means of a mobile telephone, on a computer's screen, enables the user to parameterize use from a mobile telephone, thanks to functions not accessible with the mobile telephone. In addition, at least each application or each service that can be utilized with a mobile telephone can be utilized with a computer.

According to particular features, during the tree-structure creation process the user utilizes the second terminal and drags or copy/pastes representations in the portion of the displayed screen simulating the representations as they appear on the mobile telephone's screen in order to realize the matching step.

According to particular features, during the selection step, if the user presses on a pre-defined first keypad key other than “1” to “9”, the display on the communicating mobile telephone's screen loops back and displays what was displayed one iterative cycle earlier.

According to particular features, during the selection step, if the user presses on a pre-defined second keypad key other than “1” to “9”, the display on the communicating mobile telephone's screen loops back to the first iteration.

According to particular features, during the selection step, if the user presses on a pre-defined third keypad key other than “1” to “9”, the display on the communicating mobile telephone's screen comprises explicit titles of the nodes and leaves displayed.

According to particular features, during the selection step, if the user makes a long press on one of the keypad keys “1” to “9”, a contextual help feature is opened linked to the node or leaf corresponding to said key on which a long press was made.

Thanks to each of these last four provisions, navigating in the tree-structure is very easy.

According to particular features, at least part of the computer applications corresponding to the leaves of the tree-structure are among the following:
downloading and/or displaying a text,
downloading and/or displaying a photo,
downloading and/or playing (streaming) a music file,
downloading and/or playing (streaming) a video file,
initiating a telephone call (with 1 or more people),
initiating the sending of SMS (acronym for “short message system”) or MMS (acronym for “multimedia message system”),
initiating the sending of electronic messages (“e-mails”),
selecting in a list or lists and transmitting the selection to the server,
filling out a form or template then sending it to the server and
invoking a pre-defined web service.

In this way, the main actions demanded on the web can be initiated by the navigation described above.

According to particular features, the process as described in brief above comprises a step of personalization, by the user, of the tree-structure implemented in response to navigation requests from his or her communicating mobile terminal.

In this way users can define, for example by accessing the server via the Internet, possibly via a personal computer, the tree-structure in which they will navigate from their communicating mobile terminal.

According to particular features, the process as described in brief above comprises a step defining a user profile formulating, by said user, the behavior of at least one computer application associated to a leaf of the tree-structure varying according to the user's formulated profile.

According to a fourth aspect, this invention envisages a device for creating, organizing, delivering, using and/or accessing applications, characterized in that it comprises a means of matching applications with a tree-structure, at least two said applications coming from the web, and:
a means of displaying, on a communicating mobile terminal's screen, representations of nodes or descendant leaves of the same node or the root of the tree-structure,
a means of selecting, on said mobile terminal, one of said displayed representations,
a means of communicating, by the mobile terminal to the server, an indication of the node or leaf corresponding to the representation selected,
a means of supplying, by the server to the mobile terminal, identifiers of the nodes or descendant leaves of the node selected if a node had been selected so that the display, selection and communication means carry out another iteration and
a means of initiating an application from the web if its representation is selected.

This invention also concerns a process and a device for routing data.

Many people have access to several communications channels (home fixed telephone, office fixed telephone, mobile telephone, fax, electronic mail address and instant message address, for example). However, in order to communicate with them, it is necessary to try one channel and then, if that is not successful, another and so on. This procedure causes a lot of time to be lost by a person trying to contact them and leads to duplicate messages being left for the recipient.

The aim of the present invention is to remedy these drawbacks.

To this end, according to a fifth aspect, the present invention envisages a process of routing data to be transmitted to a recipient associated to a plurality of reception channels, which comprises, in a routing server:
a step of receiving data to be transmitted, said data being associated to an identifier of the recipient,
a step of determining a context for transmitting data to the recipient,
a step of selecting at least one reception channel associated to said recipient according to said context and
a step of transmitting data on each reception channel selected.

Thanks to these provisions the channel, or channels, used to transmit the data to the recipient varies according to the context.

According to particular features, said context is representative of an identifier of said data's issuer.

Thanks to these provisions, the user can request that the data from at least one contact is sent to him or her on a pre-defined channel or on all the channels allowing data transmission, for example. Conversely, the authorities or a line manager of the recipient can order things so that any datum from them is transmitted by all the reception channels associated to the user.

According to particular features, said context is representative of a timestamp of said data.

Thanks to these provisions, the user can request that the data coming to him or her during office hours are transmitted on a pre-defined channel while the same data arriving outside office hours will be sent to him or her on another pre-defined channel.

According to particular features, said context is representative of the content of the data to be transmitted.

Thanks to these provisions, the user can request that the data from a message comprising a specific reference (for example a file number) are sent to him or her on a pre-defined channel.

According to particular features, said context is representative of an access to a channel available for the user.

Thanks to these provisions, when the user does not have access to the mobile telephone network, for example, he or she can request that the data is sent to him or her on a fixed line.

According to particular features, said context is representative of a priority for channels.

Thanks to these provisions, the user can request that a message's data are sent to him or her on a first pre-defined channel, that if he or she does not confirm reception in a pre-defined length of time, the data will be transmitted to him or her on a second pre-defined channel, and so on.

In this way one avoids duplicating the content of the message on different channels while optimizing the chances of the data being received quickly by the user.

According to particular features, during the selection step, a table is utilized correlating parameter values of the context and data transmission channels.

Thanks to these provisions, selection is easy and the correlation table can be easily edited by the user.

According to particular features, during the transmission step, data is formatted according to the transmission channel on which the data are transmitted.

In this way, one can easily switch from voice to text, or vice versa, from electronic mail to a short message, or vice versa, etc.

According to particular features, during the transmission step an application program is created based on the data to be transmitted and the application program is transmitted to the user.

According to a sixth aspect, the present invention envisages a device for routing data to be transmitted to a recipient associated to a plurality of reception channels, which comprises, in a routing server:
a means of receiving data to be transmitted, said data being associated to an identifier of the recipient,
a means of determining a context for transmitting data to the recipient,
a means of selecting at least one reception channel associated to said recipient according to said context and
a means of transmitting data on each reception channel selected.

This invention also concerns a process and a device for connecting people.

Currently, organizing a telephone conference is a very tedious process. An organizer must reserve a number assigned to this conference, contact each correspondent individually and tell them on what date and time they must call this number. In addition, before they are connected, the contacts cannot know the telephone conference's status.

The aim of the present invention is to remedy these drawbacks.

To this end, according to a seventh aspect, the present invention envisages a process for connecting users of communicating mobile terminals, that comprises:
a step of initiating the communication, by a first user,
a step of selecting, by said first user, at least two users known as “second users”,
a step of notifying, by a server, each second user selected, during which each second user receives information from a graphical interface representing the first user and each other second user selected,
when the communication is accepted by a second user, a step of connecting the first user and each second user having accepted the communication.

Thanks to these provisions, each second user can view the people taking part in the telephone or video conference to which he or she has been invited. This service makes it possible to put several remote users into contact simultaneously, via their mobile telephones, without having had to prepare or book a conference (audio and/or video).

According to particular features, the process as described in brief above, comprises, in addition, a step of reserving, by said server, a number assigned to said conference and, during the step notifying each second user selected, each second user selected receives said number assigned to the conference and, during acceptance of the communication by a second user, this second user enters into communication with every other user by means of the number assigned to the conference.

Thanks to these provisions, managing the conference is simplified.

According to particular features, during the notification step, each second user receives information from the graphical interface representing, for each other second user, whether they have already accepted the conference.

Thanks to these provisions, each second user can view the people already participating in the conference.

According to particular features, during the notification step, each second user receives information from the graphical interface representing, for each other second user, whether they have refused the conference.

Thanks to these provisions, each second user can view the people who will not take part in the conference.

According to particular features, during the notification step, the first user receives information from the graphical interface representing, for each second user, whether they have already accepted the conference and the process that is the subject of this invention, as described in brief above, comprises a step of initiating the conference, by the first user, during which the first user and each second user who has accepted the conference are put into communication.

Thanks to these provisions, the first user can delay the start of the conference while waiting for such or such a second user. In this way he or she can avoid being billed for a communication without certain essential contacts participating in the conference.

According to particular features, during the selection step, the first user selects a computer application in which a set of potential second users is pre-defined.

Thanks to these provisions, selection is easy and can be carried out by means of a single icon.

According to particular features, during the notification step, different types of communication channels are utilized with the different second users.

In this way, the notifications can be multimodal, according to the second contacts' communications capabilities.

According to particular features, during the notification step, if there is no response from a second user, said absent second user is notified again by means of a different communication channel from the one used for the first notification of the absent second user.

Thus, a contact who has not responded via a mobile telephone can be called on a fixed telephone, for example.

According to particular features, the process that is the subject of this invention, as described in brief above, comprises a step of requesting each person participating in the conference for authorization to record and, if there is authorization, a step of recording the conference content and a step of making said recording available to each of the conference's participants.

According to particular features, if there is a call for the first user during the notification step, the call is refused.

Thanks to these provisions, one avoids having a third party, who has not been invited to the conference, disrupting the proceedings.

According to particular features, the process comprises, once the conference has been established between the first user and each second user who has accepted the conference, a step of displaying on a graphical interface an identification of the person who is speaking.

Following the conference is therefore made easier.

According to particular features, the first user is not in audio communication until at least one second user has accepted the conference.

This thus avoids the first user being billed for the call while waiting for the conference to be accepted by the second users.

According to an eight aspect, the present invention envisages a device for connecting users of communicating mobile terminals, that comprises:
a means of initiating the communication, by a first user,
a means of selecting, by said first user, at least two users known as “second users”,
a means of notifying each second user selected, by a server, designed to transmit to each second user receives information from a graphical interface representing the first user and each other second user selected,
a means of connection designed, when the communication is accepted by a second user, to connect the first user and each second user having accepted the communication.

This invention also concerns a process and a device for transforming web pages. It applies, in particular, to the transformation of web pages intended to be accessed by a computer into pages accessible with a communicating mobile terminal presenting few resources (especially memory and processing capability) such as, for example, a mobile telephone or personal digital assistant equipped with mobile communication functions.

The web's success is due, in part, to the fact that the page description language, HTML (acronym for “HyperText Markup language”) and Javascript (programming language for dynamic pages) are supplied by the web servers to the navigators in the form of source text. This has, firstly, avoided having to define binary representations that may be dependent upon a platform and, secondly, has meant that any user can learn to create pages simply by examining the descriptive code of already available pages.

But this imposes a heavy workload on the recipient terminal's navigator since it must analyze the descriptive code and the Javascript before it can, respectively, display them and execute them. This is not a constraint for modern personal computers with large computing power, a large storage capacity and quick network connection, but it becomes a problem in restricted environments such as mobile telephones, especially entry-level or mid-range ones.

The aim of the present invention is to remedy these drawbacks.

To this end, according to a ninth aspect, the present invention envisages a process for transforming web pages, characterized in that it comprises, in order to transform a web page for displaying on a communicating mobile terminal:
a step of receiving a web page comprising an HTML content and Javascript,
a step of pre-analyzing, by a gateway server, characteristics of the formatting of said page's HTML content,
a step of transforming the HTML content and its formatting into a compact binary form, on the gateway server,
a step of compiling, on the gateway server, said page's Javascript into instructions directly executable by the communicating mobile terminal and
a step of supplying said communicating mobile terminal with the compact binary form of the HTML content and instructions.

Thanks to the utilization of the present invention, mobile telephones with limited capability are able to display web pages written in HTML, and also execute Javascript code, by processing these elements in a gateway between the telephone and the website.

According to particular features, during the compilation step, the page's Javascript is compiled into “bytecode” instructions directly executable by the communicating mobile terminal.

According to particular features, the process that is the subject of this invention, as described in brief above, comprises, in addition, a step of associating Javascript code contained in the page and at least one native function of the mobile telephony part of the communicating mobile terminal.

These native functions are, for example, sending short messages (“SMS”), establishing connections, especially in VOIP (acronym for Voice Over Internet Protocol), capturing images and consulting an address book.

According to particular features, the process that is the subject of this invention, as described in brief above, comprises, in addition, so that a navigator operating on the communicating mobile terminal accesses a web page, a step of sending, by said navigator, a request identifying the page to the gateway server and a step of sending a request identifying said page from the gateway server to the server hosting said page.

According to particular features, during the step of transformation into a binary format, a step is carried out expanding styles of the page's HTML content defining the appearance of elements of the page's HTML content.

According to particular features, said styles are CSS styles (acronym for Cascading Style Sheets).

According to particular features, during the step of transformation into a binary format, the page's DOM (acronym for “Document Object Model”) interface is kept accessible.

This DOM interface therefore remains available to enable the construction of interactions local to the communicating mobile terminal not involving the original server.

According to a tenth aspect, the present invention envisages a device for transforming web pages, characterized in that it comprises, in order to transform a web page for displaying on a communicating mobile terminal:
a means of receiving a web page comprising an HTML content and Javascript,
a means of pre-analyzing, by a gateway server, characteristics of the formatting of said page's HTML content,
a means of transforming the HTML content and its formatting into a compact binary form, on the gateway server,
a means of compiling, on the gateway server, said page's Javascript into instructions directly executable by the communicating mobile terminal and
a means of supplying said communicating mobile terminal with the compact binary form of the HTML content and instructions.

This invention also concerns a process and a device for transforming web pages. It applies, in particular, to the transformation of web pages intended to be accessed by a computer into pages accessible with a communicating mobile terminal presenting few resources (especially memory and processing capacity) such as, for example, a mobile telephone or personal digital assistant equipped with mobile communication functions.

The web's success is due, in part, to the fact that the page description language, HTML (acronym for “HyperText Markup language”) and Javascript (programming language for dynamic pages) are supplied by the web servers to the navigators in the form of source text. This has, firstly, avoided having to define binary representations that may be dependent upon a platform and, secondly, has meant that any user can learn to create pages simply by examining the descriptive code of already available pages.

But this imposes a heavy workload on the recipient terminal's navigator since it must analyze the descriptive code and the Javascript before it can, respectively, display them and execute them. This is not a constraint for modern personal computers with large computing power, a large storage capacity and quick network connection, but it becomes a problem in restricted environments such as mobile telephones, especially entry-level or mid-range ones.

The aim of the present invention is to remedy these drawbacks.

To this end, according to an eleventh aspect, the present invention envisages a process for transforming web pages, characterized in that it comprises, during a step of receiving a web page:
a step of extracting at least one hypertext link from the content of the page and
a step of displaying each link extracted from the content of the page.

Thanks to these provisions, before the entire content of the page has been received, the user already has links allowing him or her to navigate to other pages or animations. Thus he or she does not have to wait until the page has finished loading to go to another page. The user therefore saves time, especially when he or she knows the page being loaded and does not want to see it.

According to particular features, during the display step, at least one extracted link is associated with a graphic representation and said graphic representation is displayed on a screen.

Thanks to these provisions, the representation of links is more intuitive and can be standardized.

According to particular features, during the extraction step, at least one said graphic representation is extracted from the content of the page being received.

Thanks to these provisions, a site can provide graphic representations to be displayed, in front of the page content, in order to help users that have terminals with limited capability for receiving, displaying and/or processing contents.

According to particular features, during the display step, at least one link is associated with one said graphic representation extracted from the content of the page being received, according to the display screen's resolution.

According to particular features, during the display step, a link is associated with a said graphic representation extracted from the content of the page being received, according to the reception speed for the page.

According to particular features, during the display step, a link is associated with a said graphic representation extracted from the content of the page being received, according to an estimated duration for receiving the page.

Thanks to these provisions, a terminal with high capabilities of reception, display and processing can wait for the page to finish loading before displaying it, for example less than one second, and, in contrast, a terminal with more limited capabilities can quickly benefit from means of navigating from the page being received.

According to particular features, at the end of the page reception step, access is given to the content of the page by means of a dedicated graphic representation, while keeping the display of links extracted from the page content.

Thanks to these provisions, the user can switch from only displaying links, possibly associated with graphic representations, to displaying the entire page.

According to a twelfth aspect, the present invention envisages a device for transforming web pages, characterized in that it comprises a means of receiving a web page and a means of processing designed, during the reception of a page, to:
extract at least one hypertext link from the content of the page and
display each link extracted from the content of the page.

According to a thirteenth aspect, the present invention envisages a computer program, characterized in that it comprises instructions that can be executed by a computer in order to implement the process that is the subject of this invention, as described in brief above.

According to a fourteenth aspect, the present invention envisages a data carrier that can be read by a computer and comprising instructions that can be executed by a computer in order to implement the process that is the subject of this invention, as described in brief above.

As the particular characteristics, advantages and aims of this device, this computer program and this data carrier are similar to those of the process that is the subject of this invention, as described in brief above, they are not repeated here.

The processes that are the subjects of the first, third, fifth, seventh, ninth and eleventh aspects of this invention are intended to be utilized together to form a complete communications system combining the advantages described with respect to these different aspects.

Similarly, the devices that are the subjects of the second, fourth, sixth, eighth, tenth and twelfth aspects of this invention are intended to be utilized together to form a complete communications system combining the advantages described with respect to these different aspects.

Other advantages, aims and characteristics of the present invention will become apparent from the description that will follow, made, as an example that is in no way limiting, with reference to the drawings included in an appendix, in which:

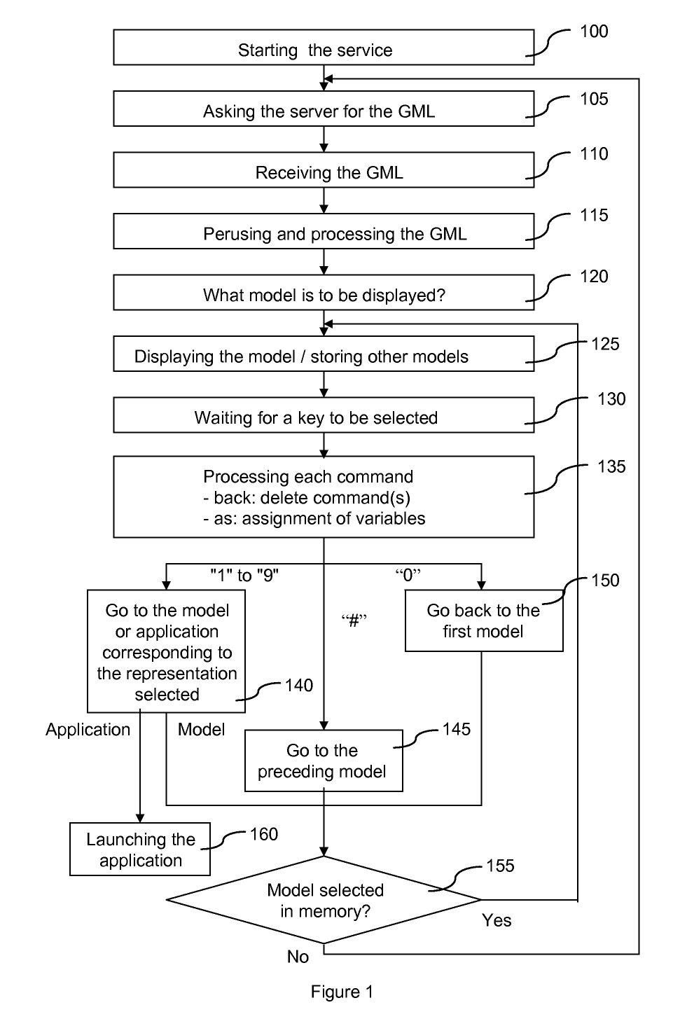

FIG. 1 represents, in the form of a logical diagram, steps of a communication utilized in at least one particular embodiment of the process that is the subject of this invention,

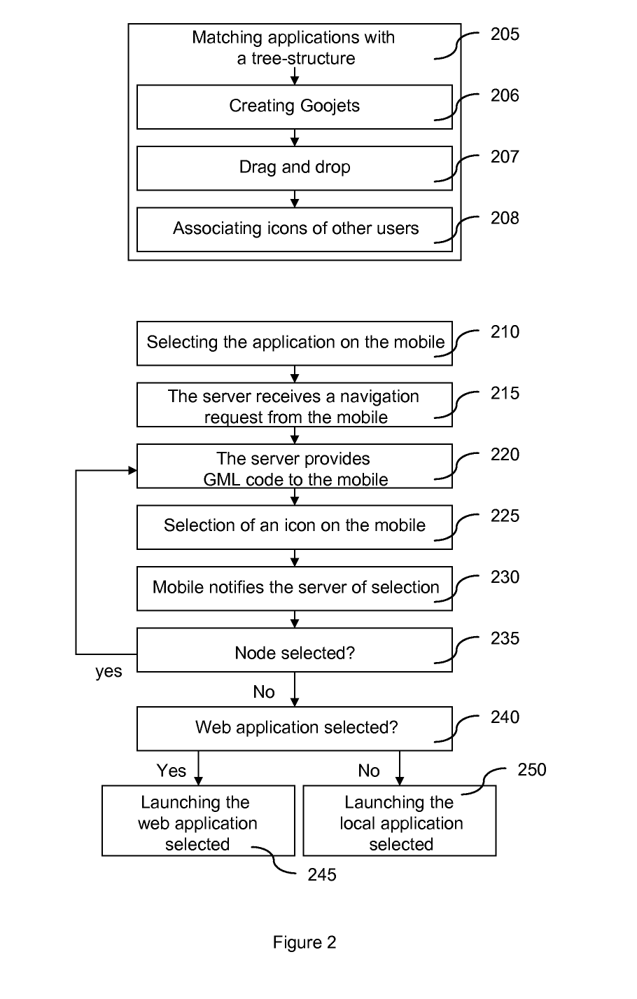

FIG. 2 represents, in the form of a logical diagram, steps utilized in a particular embodiment of the process that is the subject of this invention,

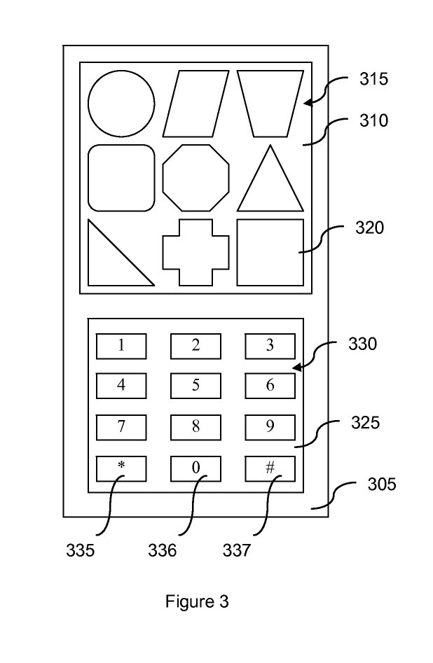

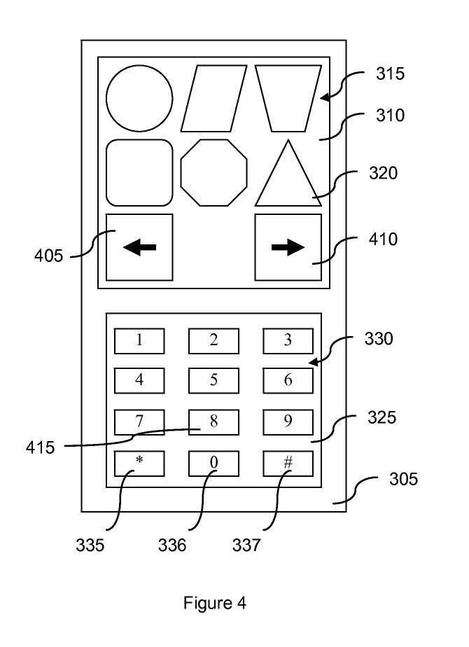

FIGS. 3 and 4 represent, schematically, user interfaces utilized, on a user mobile terminal, in different embodiments of the process that is the subject of this invention,

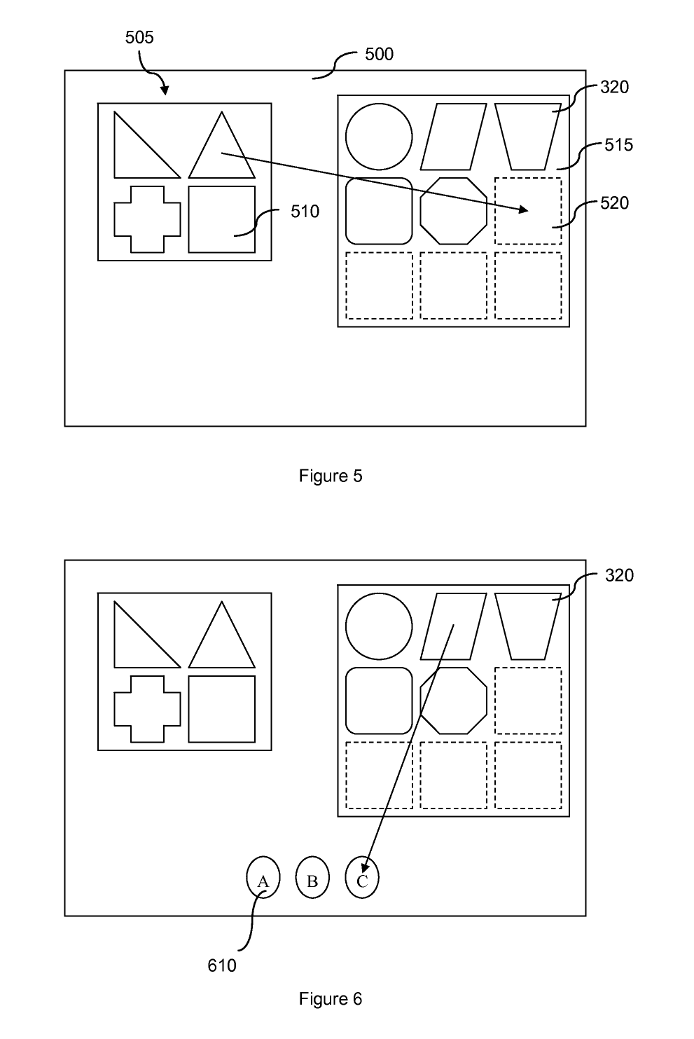

FIGS. 5 and 6 represent, schematically, user interfaces utilized, on a computer screen, in different embodiments of the process that is the subject of this invention,

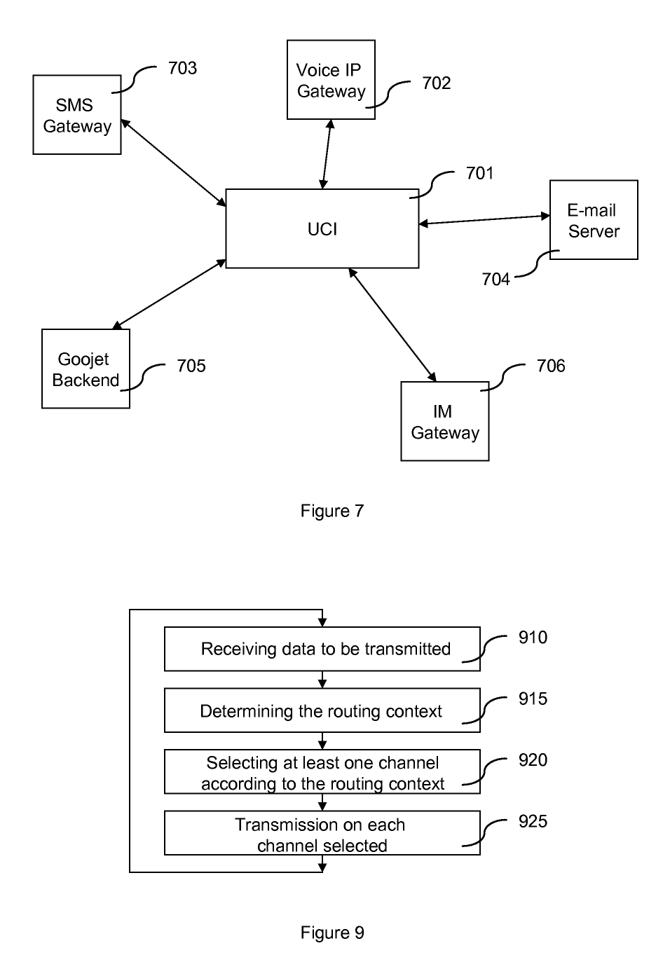

FIG. 7 represents, schematically, a unified communication infrastructure utilized in particular embodiments of this invention,

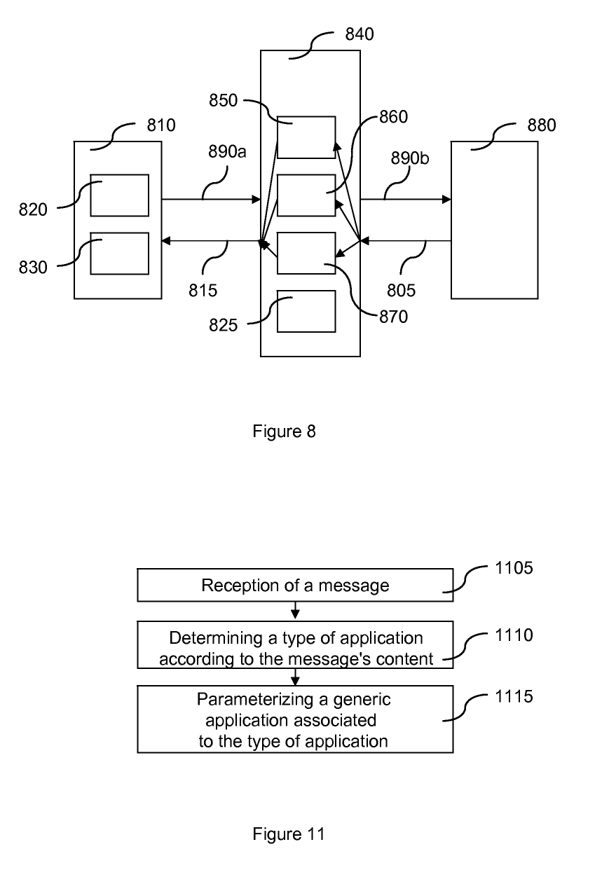

FIG. 8 represents, schematically, a gateway server for utilizing a navigator that is the subject of one of the aspects of this invention,

FIG. 9 illustrates, in the form of a logical diagram, steps utilized in a routing server, according to an aspect of this invention,

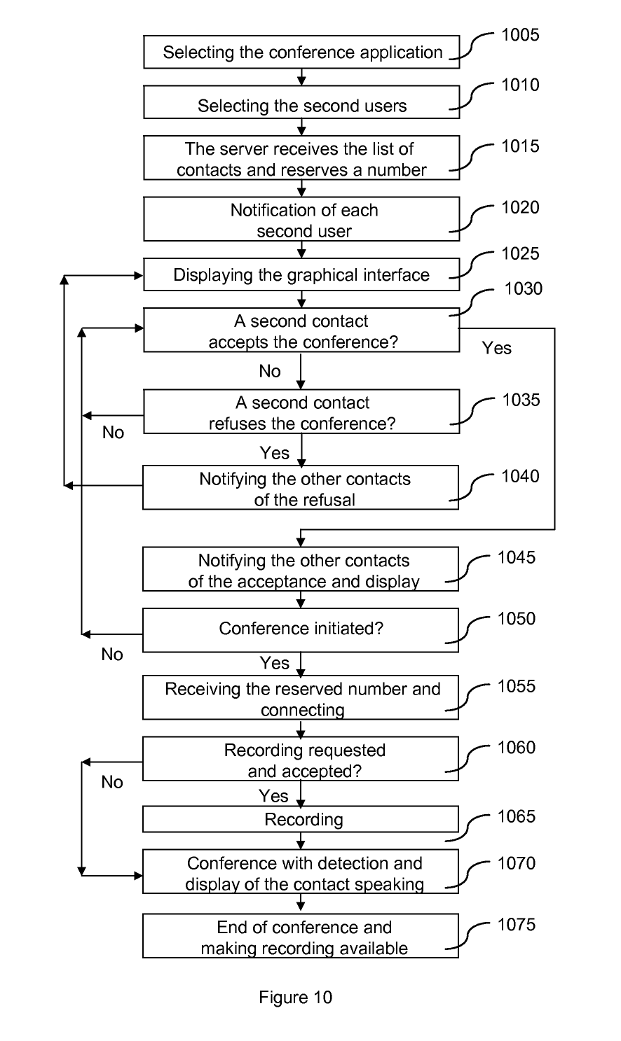

FIG. 10 illustrates, in the form of a logical diagram, steps utilized in a conference application,

FIG. 11 illustrates, in the form of a logical diagram, steps utilized in an automatic creation of a computer application,

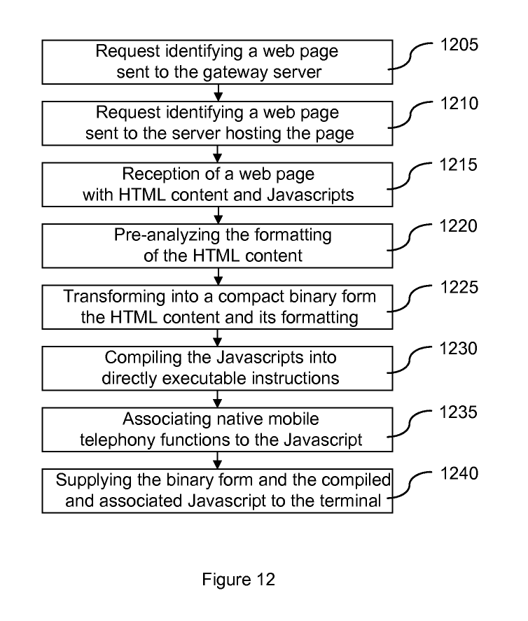

FIG. 12 illustrates, in the form of a logical diagram, steps utilized in order to transform a web page for displaying it on a communicating mobile terminal and

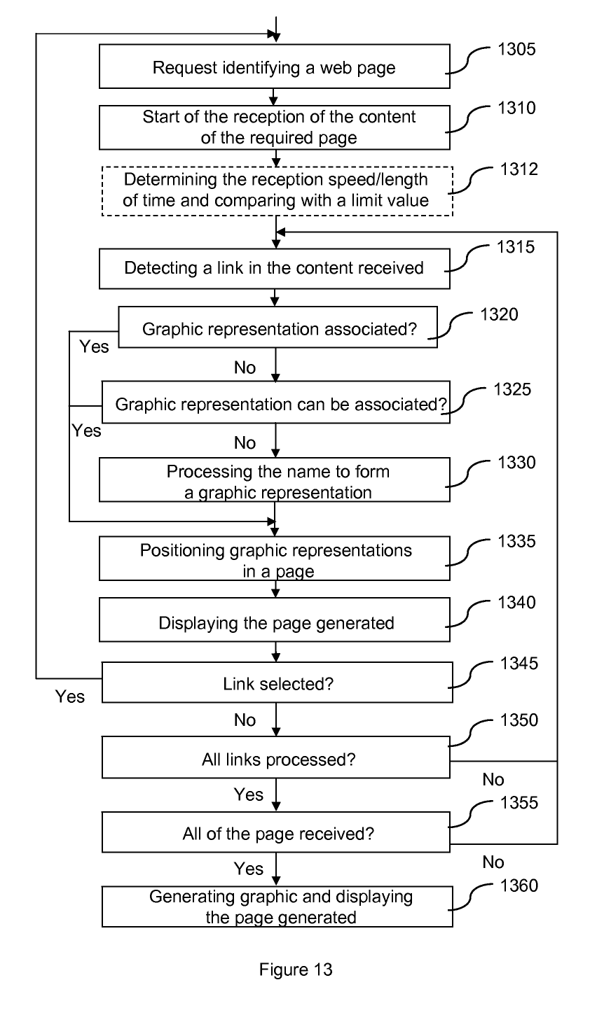

FIG. 13 illustrates, in the form of a logical diagram, steps utilized in order to transform a web page for rapidly displaying hypertext links on a communicating mobile terminal.

Throughout the description, the following definitions are used:
“Application”, a program interacting with an execution context,
“Service”, the response to a user's request, independent of the context, for example “get a cab”, “book a table”. It is noted that a web service is an application. It is noted that the installation of the service generally requires the installation of applications and
“mobile”, a communicating mobile terminal, for example a mobile telephone, a personal digital assistant (“PDA”) or a “smartphone” that comprises both mobile telephony functions and personal digital assistant functions.

The hardware structure supporting the services utilized by this invention is based on a distributed architecture comprising:
a backend portion residing on a set of servers, jointly called “the server” in the rest of the description, portion accessible, with regard to its configuration, via Internet (see FIGS. 5 and 6), and
portions known as “mobiles”, residing on communicating mobile terminals, accessing the server via standard data links offered by mobile telephony operators and/or by local wireless links (for example, Bluetooth or WiFi, registered trademarks).

A new communication protocol, or language, defined for utilizing the present invention, called “GML” (acronym for “Goojet Markup Language”, Goojet being a registered trademark) and utilizing tags, handles the interactions between the server and the mobile portions. This language is described with regard to FIG. 1.

It is noted that the term “GML” designates the tree-structure concept of service structure and which can be materialized by proprietary XML representations (“Goojet”) as well as by standardized HTML representations. It is the structured approach.

In addition to their distributed structure, these services are also original in their behavior, which is distinguished from the state of the art of existing mobile services by the following characteristics:
they are user-centric, i.e. the behavior and presentation of these services can be adapted to each user, unlike a generic behavior,
they have a ubiquitous nature, i.e. these services are designed, from the beginning, to be accessed both by a mobile (called “mobile” access) as well as a computer connected to the Internet (called “web” access),
they are community-based: these services allow several users to share common data, for both reading and writing, whatever their access means (mobile or web), and
they utilize a navigable space: these services are organized together by a referencing mechanism that allows users to navigate through all these services by successive steps from a mobile.

The platform described here is heterogeneous in that it allows different types of services to be organized, accessed and used:
simple services for accessing remote information (text, rich text, photo, video, music, RSS child node, web page, etc),
services created by the company managing the platform,
mediation services to web services belonging to third-parties,
interactive and transactional services based on an end-to-end transaction management system, stateful, between the users and the remote services and
services created by the users themselves, by aggregating and configuring individual bricks into complex and personalized wholes, or by developing original services based on the rules and interfaces provided by the company that owns the platform.

The innovations offered by utilizing this invention cover several fields:
the structure of the distributed objects and the communication protocol (called GML and described in an appended paragraph) that, together, allow the implementation of services or applications that are the subjects of this invention,
the structure that allows all of these services to be organized, managed and exploited, this set being called the “service space” and comprises all the user's services and nodes and
certain services that are the subjects of this invention.

The infrastructure is based on a man-machine interface located remotely on the mobile, a matrix navigator representing three times three icons, a web menu and a recursive structure.

One of the foundations of the architecture is the “intelligent” distribution of work (processing, data, presentation) between the mobile and the server: each service is split into:
a presentation portion on user interfaces, the aspect and behavior of which are modeled in GML language, and
a fat portion, on the server, comprising data, data processing and interfaces with other components (external web services, other users, etc).

The “fattest” portion thus resides on the server and is accessible via the Internet, on the one hand, and via the mobile, on the other hand. Thanks to this model, the mobile is freed of heavy processing. For example, each access to a given service is adapted to the user. This distribution of loads and this synchronization on request between the web and the mobile via the GML protocol is, in part, an extrapolation, adapted to the mobiles, of the “thin client” model with a web navigator. The runtime mobile can therefore be considered to be a new type of navigator, specifically adapted to the structure of the services that are the subject of this invention and to the organization of their space.

FIG. 1 shows a step 100 of starting the service implementing the present invention, for example by selecting an application held on the mobile utilized. When the application implementing the services that are the subject of this invention is opened, the screen of the mobile:
either displays a menu in the 3×3 matrix format, called the “local host menu”, present on the telephone,
or, which is assumed in the rest of the description of FIG. 1, issues a request to the server that handles the navigation, asking it, in GML language, for the home page to be displayed for the user in question, especially when it has already been identified, during the step 105. In this second case, during the step 110, the server supplies the mobile with the code that describes at least one matrix of icons, in GML language. It is noted that the request issued by the mobile during the step 105 allows the server to identify the user or, at least, a part of his or her profile.

The “presentation” portion is therefore sent, on request from the mobile, from the server to the mobile. This presentation portion is interpreted immediately by this mobile, in which there is a GML interpretation environment (referenced under the “runtime mobile” code): during a step 115, the mobile peruses the code received during the step 110 in order to extract from it a model, or page, to be displayed.

During a step 120, the mobile determines, from an identifier of the user or his or her mobile, the model to be displayed on the screen, as the user's personal home page. This home page is formed and parameterized by the user, as described with reference to FIGS. 5 and 6, preferably by access, with a computer, to a dedicated web server. During a step 125, the mobile displays the model found, as described with reference to FIGS. 3 and 4, and by means of prefetch stores models that may be called from the user's home page.

During a step 130 the mobile waits for and detects the selection of a key on its keypad. Once the selection of a key on the mobile's keypad is detected, the mobile processes the meaning of the selected key, or command, during one of steps 140 to 150.

If the selected key is one of the numeric keys “1” to “9”, during a step 140, the mobile processes the content of the tree-structure corresponding to this key and, if the selected icon corresponds to an application not utilizing a model, launches this application. In contrast, if a selected key concerns a new node of the tree-structure or a host model or navigation model in an application called the “fruit node” of the tree-structure, a new model is selected and step 155 is proceeded to.

If the selected key is “0”, the mobile returns to the first model, corresponding to the user's personal home-page, during a step 150.

If the selected key is “#”, the model goes back to the preceding model, during a step 145. If two keys are selected simultaneously, consisting of the “#” key and a number “i” represented by the number displayed on one of the keys “1” to “9”, then during the step 145, the navigation history “i” model(s) back is deleted. For example, if one reaches the fourth model coming from the second model, the command “#” and “2” allows the user to delete the navigation history of the last two models displayed, i.e. to return to the second one displayed. In this way, the server is able to manage a navigation history for the user.

In the case where one of the icons displayed (see FIG. 3 or 4) corresponds to a variable assignment, or parameter setting, the management of variables allows an operational scope or context for the mobile to be determined. This context defines a validity environment for variables during the navigation and the associated variables as well as their default value. For this purpose, using a command known as “as:var:value”, which comprises the successive selection of the key of the mobile's keypad associated to the variable assignment icon and a key representing a value “var” represented by the value of a key between “1” and “9”, makes it possible to position the “var” value at the variable “value”. Thus, in the very interior of the GML language (and without implementing a new client-side language), one is able to interpret a command and carry out a simple operation. The value of the variable can be retrieved inside the language by using the signs “{” and “}”. The value of “var” is therefore represented by “{var}”.

After one of steps 140 to 150, during a step 155, the mobile determines if it has the selected model in cache memory, thanks to the prefetch carried out during the step 125. If yes, step 125 is proceeded to, to display the selected model and prefetch the models that the selected model can lead to. Otherwise, step 105 is returned to, to request the selected model from the server.

FIG. 2 represents steps utilized in an embodiment of the process that is the subject of this invention.

During a step 205, applications are matched with a tree-structure, at least one said application coming from the web. This matching is carried out in three steps:
firstly, step 206, services are created, where the service's creator can be either a partner, the manager of the services that are the subjects of this invention, a user or automatically, from an electronic mail (“e-mail”) able to cause the creation of an application supporting such a service. This creation is generally carried out from generic applications (or “metagoojets”), i.e. generic applications whose parameters are not assigned to any value and which, once parameterized, become services (or “Goojets”). For example, a generic weather application called “meteo” uses a location value as a parameter and receiving an electronic mail with “meteo Toulouse” as its title assigns the value “Toulouse” to the location parameter.
secondly, step 207, the user drags and drops available icons or graphics representing the services created, for example in drop-down menus or by means of a 3×3 matrix tree-structure catalog or search dialog box, as described with reference to FIG. 5 and
finally, during a step 208, the user can associate service icons to the icons of other users (friends or contacts) in order to propose these services to them or, reciprocally, drag and drop icons proposed by friends or contacts, as described with reference to FIG. 6.

Following the step 208, the applications supporting the services and the tree-structures are kept by the server. The user thus has a personal navigation space which he or she can access either by using a mobile or by using a terminal connected to the Internet.

During a step 210, the user selects the application implementing the present invention. It is assumed, here, that a mobile is used.

According to embodiments, either the mobile then sends a request to the server, asking it for this user's current home page, or the last home page utilized is displayed immediately. It is assumed, here, that the first variant is utilized. Thus, during a step 215, the server, linked to an application database, receives a navigation request from the communicating mobile terminal.

During a step 220, the server supplies the mobile with code written in GML that describes at least one icon matrix. Among these matrices, one constitutes a home screen and is immediately displayed by the mobile.

During a step 225, the user carries out, with his or her mobile, a step selecting one of said nodes or one of said leaves. This selection is carried out by pressing one of the nine keys of the keypad from “1” to “9”, in line with what is displayed on the screen. For example, the topmost left-hand icon is selected by pressing the key “1”.

During a step 230, the mobile communicates an identifier of the selected node or leaf to the server.

During a step 235, the server determines whether a node has been selected. If yes, the server goes back to step 220 and supplies the mobile with identifiers of the nodes or descendant leaves of the node selected and a new iteration is carried out of the steps selecting, communicating and determining the type of icon selected. If the result of step 235 is negative, during a step 240 the server determines whether an application from the web has been selected. If yes, the server launches this selected application, during a step 245.

Otherwise, during a step 250, the application held on the mobile that has been selected is utilized. In the embodiment described here, at least one such application utilizes as user interface the same 3×3 matrix layout associated to 9 keys of the mobile's keypad.

A navigation with nine keys is described below, utilized in particular embodiments of the process and device that are the subjects of this invention.

As illustrated with regard to FIGS. 3 and 4, the user sees, on the screen 310 of his or her mobile terminal 305, a series of matrices 315 of icons 320 and can very easily select one of the branches of the tree-structure and then a leaf or a fruit (application using the mobile navigator defined below) at the end of the tree-structure.

“Mobile navigator” is used to refer to any navigator dedicated to the services space, for example in the form of a 3×3 matrix. This navigator can be on any type of medium, web page or terminal.

This “nine key navigation” is a navigation solution that allows a user to use the keys 330 “1” to “9” of a digital keypad 325, for example of a mobile telephone, to interact with an application displaying, on the screen 310 in relation to the keypad, nine representations 320 of functions, for example in graphic form and, more particularly, in the form of icons.

The “nine key navigation” system is generic and can be used on any physical or logic device whatsoever, such as a mobile telephone or a software gadget embedded in a website (“widget”). The description made here, for reasons of simplification, assumes that this navigation system's host device is a mobile telephone, subsequently called “mobile”. In effect, a mobile telephone is especially suited to this mechanism because of its small screen, which entails management adapted to the space and the navigation, on the one hand, and because of the presence of keys numbered from “1” to “9” on its keypad, organized into a 3×3 matrix, on the other hand.

The aim of the “nine key navigation” is to use the keys numbers “1” to “9” on the keypad 325 of the mobile 305 in order, firstly, to navigate in a local or remote services space (extended menu concept) and, secondly, to use the services thus accessed. This navigation therefore serves not only as a navigation interface but also as an interface for using certain applications, called “fruit nodes”, at the end of the tree-structure. The allocation between the mobile's physical keys and the interface is done by using a 3×3 matrix, as follows:

$$\begin{matrix}1 & 2 & 3 \\ 4 & 5 & 6 \\ 7 & 8 & 9\end{matrix}$$

Among these matrices, one constitutes a home screen and is immediately displayed by the mobile, during the step 125.

In the case illustrated in FIG. 3, where at least nine icons are to be displayed, this screen is constructed in the form of a 3×3 matrix (three rows of three columns) corresponding, by homothety, to the nine numbers “1” to “9” in the matrix of the keypad 325 of the mobile 305. At each moment there is therefore displayed on the screen 310 of the user's mobile 305 a 3×3 matrix presenting nine items of data in the form of nine icons 320.

When more than nine icons 320 are to be displayed, for preference and as illustrated in FIG. 4, only six of them are displayed, for example on the top part of the screen (two rows of three columns) and the next rows are assigned as follows:

$$\begin{matrix}⇐ & 8 & ⇒ \\ * & 0 & \#\end{matrix}$$

Arrows 405 and 410 corresponding to keys “7” and “9” make it possible to scroll the icons 320 displayed in the first two rows among all the icons 320 to be displayed in the page in question.

Thus, when a selected node comprises more than nine icons 320, only the six positions of the top two rows (2×3) are assigned to icons 320 and icons 405 and 410 of the third row allow the icons 320 on the first two rows to be scrolled, the “7” being associated to a left arrow 405 (previous) and the “9” being associated to a right arrow 410 (next). The middle key 415 of the third row of icons, corresponding to “8” on the keypad, is not used for navigation and remains available for functions chosen by the application. This type of navigation node corresponds to a representation of two rows of icons on a virtual cylinder and enables a navigation tree-structure to be generated in which the nodes comprise an unlimited number of options (icons), while keeping within the same paradigm of “one-finger” navigation. The system automatically adapts the display format of a node (3×3 or virtual cylinder) when options descending from the same node are dynamically added or removed, according to whether their number is less than or equal to nine or greater than nine.

In the case of mobile telephones, navigation is also based on keys 335 to 337 “*”, “0” and “#”, respectively assigned to the following navigation functions:
key 335, “*”, allows the user to access help in the form of text superposed on the icons, where this text, very short, briefly explains the content represented by each icon,
key 336, “0”, allows the user to return directly to the user's current home page and
key 337, “#”, allows the user to go directly to the previous page.

Selecting an icon leads to one of the following actions:
if the icon selected by pressing on a keypad key is a “node” for navigating in the services tree-structure, another icon matrix page is opened (with a maximum of 3×3 icons); the user thus navigates to a greater depth where, recursively, he or she obtains an icon matrix or
a terminal action is invoked: the selected icon corresponds to a leaf of the services tree-structure; the user has reached the end of his or her navigation with respect to the path followed and invokes the service.

There are two types of terminal actions:
“atomic” actions: the navigation infrastructure has a certain number of possible atomic terminal actions that, together, enable a service to be constructed, by successive aggregation and by hierarchical and recursive organization. These atomic terminal actions include (non-limiting list):
   downloading and/or displaying a text,
   downloading and/or displaying a photo,
   downloading and/or playing (streaming) a music file,
   downloading and/or playing (streaming) a video file,
   initiating a telephone call (with 1 or more people),
   initiating the sending of SMS (acronym for “short message system”) or MMS (acronym for “multimedia message system”),
   initiating the sending of electronic messages (“e-mails”),
   selecting in a list or lists and transmitting the selection to the server,
   filling out a form or template for entering text or numeric data, then sending it to the server and
   invoking a pre-defined web service.
applications: an application is a set of procedures and actions that are executed either on the mobile or on the server, potentially interacting with the user, at the end of the navigation, but that require a higher level of sophistication than pre-defined atomic actions and which must be carried out in a single context. An application can therefore be constituted of several successive choices, several operations filling in information, and several transactions with the server, while remaining in the tree-structure leaf, i.e. remaining in a single context, without additional navigation in the tree-structure. An application is therefore distinguished by its unity of context (in the navigation sense) and its complexity, in contrast to atomic actions.

It is noted that an application can be created by aggregating several atomic actions in the same navigation context as described above, i.e. with pages comprising at most nine icons associated to the nine keys “1” to “9” of the keypad. Such an application is therefore entirely modeled by GML. It is also called, in the description, a “fruit node” of the tree-structure.

An application, always in a navigation leaf therefore, can also invoke a proper mobile executable file. Such applications do not therefore provide their service through GML interpretation, but use GML and the recursive services tree-structure to be made accessible. For this purpose, the structure utilized in the implementation of this invention is, at the same time, a set of services interpreted by GML and an organization structure, which can include heterogeneous services (pure GML or comprising a part executable on the mobile).

It is important to note that the “nine key navigation” solution makes it possible to invoke “native” services and applications (such as, for instance, the address book, the call function, a game installed by the telephone's manufacturer, etc) and remote applications/services, residing on the web and which therefore require communication and interaction with systems external to the telephone. The user therefore uses the same navigation system for all the services and the application's location is no longer significant for the user. This is an extended menu concept, where the same paradigm of navigation and use applies for going from a local navigation to a remote navigation, and also from a navigation to a terminal action within an application. The data model allowing the nine key navigation mechanism therefore breaks down the barrier between local and remote and between navigation and execution, allowing a unified and simplified view of the use.

For preference, a long press (lasting longer than a limit length, possibly parameterizable) on one of the nine keys gives access to a contextual menu with help on the content associated to the icon concerned by the press and options, such as, for example, “send the service to a friend or contact”.

The system carries out address resolution “by shortcuts” during navigation, and can position itself on a navigation's target without going through the intermediary steps (navigation nodes): for example, if a service is on the R^{th} position of the Q^{th} position of P^{th} position of the current page, the basic navigation asks for “P” to be pressed, then “Q” when the corresponding page (node) is displayed, then “R”, etc. The system offers a shortcut mechanism that allows the user to press “P”, “Q” and “R” quickly, after which actions the system goes directly to find the final position required, thus saving on the intermediary steps. These are “compression” shortcuts.

The system also allows explicit access shortcuts to be assigned for services accessible via “nine key navigation”: when organizing a space that can be navigated by the nine key navigation system, it is possible to specify the required shortcut to the system, and the system will place the service at the corresponding position in the tree-structure, if available. For example, one can indicate “63836” to the system for a Meteo service (on a mobile telephone's keypad, 63836 can correspond to the letters of the word “meteo”). This function allows the user to directly access a service without knowing where it is in the structure; these are mnemonic shortcuts.

With respect to the contents of the menus, these are dynamic. In effect, the structure of the navigation tree is constructed and stored on the server side. This allows the user to access his or her services tree-structure from several types of clients such as, for example, a web navigator on a desktop computer: the structure is unique but its access is shared and multimodal.

If the user modifies his or her services “space” by using for example a website, he or she can immediately see the changes on his or her mobile telephone. To help in this modification (or “editing”), a window represents a 3×3 matrix similar to the one that will be displayed on the mobile telephone's screen. Once the “nine key navigation” solution is installed, the user can add and delete services for his or her telephone without needing to change the telephone's configuration or install additional software.

The navigation system allows several pages to be sent to the telephone at the same time. With a “cache” system on the telephone, the system does not need to contact the server when the user navigates between the pages. Navigation on remote services can therefore be momentarily local to the telephone, thus reducing latency of access to the services. The system marks the dynamic information that must be refreshed during cache navigation. In addition, when a service or a “space” (set of services and navigation nodes forming a coherent whole, conceptually similar to a thematic portal) is defined, several individual services or nodes can be marked as “correlated” in order to force loading as a single atomic request on the telephone. The set of data loaded in this way during access to the entry point for this service or space is therefore thicker than the single datum corresponding to this entry point, but the correlation has been established to allow subsequent local (cache) navigation with no additional request to the server, thus reducing the overall latency for navigation through this service or this space.

The system keeps an exhaustive log of each navigation by each user through the tree-structure managed by this “nine key navigation” process. This log allows each user's profile to be defined dynamically, based on his or her navigation. This profile is then disclosed by the system for third-party and external uses, such as for example the targeted sending of a message to certain users based on their profile. But this profile-by-profile calculation mechanism is also used in a way that is internal and intrinsic to the nine key navigation process, through a “prefetching” algorithm based on the navigation profile: statistical navigation paths are calculated for each user and the successive services or nodes of the most frequent statistical navigation paths are dynamically correlated for each user, so that a user entering a given path triggers the atomic loading into cache of N levels of navigation on said path. Once again, the aim is to reduce the number of requests between the navigator and the server and thus reduce the overall latency. The number N of levels is calculated according to the frequency of the path and the memory available in the cache. The path's frequency is the main datum of the profile (for example, the profile determines that user Lambda, when he or she accesses node N1, will then in X % of cases access node or service N2, then in Y % of cases access node N3, etc. Such a calculation results in a statistical weight, also called a frequency, being defined for each node of the navigation path—in this case the weight of node N3 is X*Y from node N1 for user Lambda). The size of the available cache is known thanks to the navigator's static profile (according to the mobile it uses for navigating, the characteristics of which are known in a database known as static profiles database). The “prefetching” algorithm, based on the profile, dynamically correlates (i.e. this correlation decision is recalculated after each navigation) for the user all the nodes of the navigation path with a frequency above a threshold (for example 80%, the system's adjustment variable) and as long as the cache memory allows it.

This correlation decision on the navigation profile can then be refined by two additional algorithms. The first, called the “super-profile”, is related to a group profile. To simplify the calculations and make the system more powerful overall, the profile system also creates “group navigation frameworks”, enabling proactive “prefetching” to be carried out for a user who has not yet followed a certain path: the profiles of all the users are compared to each other and behavior profiles are defined. A super-profile, for a given path, is a navigation profile that corresponds, within the scope of a system adjustment variable range, to the navigation profile of several users. These users are therefore grouped together based on the uniformity of their navigation in a certain number of paths.

When a user is considered to belong to a super-profile, based on his or her navigation behavior on N paths, and he or she is going to navigate on an N+1th path for the first time, and there is a standard navigation profile for this N+1 path in the super-profile to which this user belongs, then the system will proactively correlate the elements of said path for said user, based on this super-profile, even though this user has never navigated on this path.

The second additional algorithm concerns a personalized correlation: the user has the possibility of forcing the “prefetching”, i.e. the correlation of navigation path elements, when managing his or her navigation tree-structure. The concept is similar to that of the use of caches and correlations, except that, previously, the correlation involved a set of elements together forming a homogeneous whole and thus correlated generically for all these users, while in this case the user can decide to correlate, for him- or herself only, elements of his or her tree-structure that have not, in theory, any correlation of use. This is only the personalization of his or her navigation paths and not the aggregation of elements into a homogeneous whole.

The main purpose of the intelligent cache management and the various “prefetching” algorithms is to reduce the number of requests between the navigator and the server, improving the user's experience overall (latency is less since the navigation is as local as possible). Another important purpose of local cache navigation concerns disconnected mode: the fraction of the tree-structure that is loaded into the cache remains accessible to the “nine key navigation” process even in the absence, deliberate or involuntary, of the connection between the navigator and the server. The navigation process clearly indicates to the navigator that certain data are potentially obsolete but allows their local use if there is no connection. The data are then refreshed on request during the next navigation in connected mode.

Among other things, this process, used together with the personalized correlation process described above, allows a set of data explicitly identified and organized in the overall tree-structure as a set of data, in theory heterogeneous and dispersed, to be loaded into memory, in a single request, and kept in memory. In the event of a disconnection, the portion of the tree-structure that was not loaded into memory is no longer accessible by the nine key navigation process (until the next connection) but the data in cache remain accessible through the same mechanism of navigation and use.

The structure that allows the set of services to be organized, managed and exploited is called a “space”. When a user defines services or applications or space or a part of a space, he or she can indicate the required audience for these elements, from the following choices:
public: everyone has access and therefore all the platform's users can augment their own services space by referencing this element in one of the nodes or leaves of their tree-structure.
private: this service can only be navigated or used by the user,
community: this service can be referenced (and therefore navigated or used) by a set or sets of users designated by the creator of the service.

Beyond the ability to share, this possibility gives a significant dynamic characteristic to the services space and its navigation: a user can reference, in his or her own space, a public portion of another user's space, which can be enriched, with the other user adding branches or services that are also added in the first user's navigable space. One user can also, in their turn, reference a public or community portion of a third, etc. Step by step, the spaces can therefore have an intersection with or “cross-pollinate” each other, enabling navigation by successive similarities in a living, dynamic and open space, while remaining controlled and always “user-centric”.

With respect to promoting the platform, as has been seen, a user's space is a tree-structure, with its public or private branches, chosen and/or defined by the user through a web interface. This tree-structure becomes navigable via his or her mobile and, in its leaves, leads to a collection of services. The fact that some of its branches are references to other public branches creates a first level of dynamism in the structure of this user's space, since the public branches referenced can change.

During navigation in a tree-structure, by the nine key navigation procedure, the user can, at any time, “mark” a service (or a navigation node) visited as a “favorite” (the “bookmark” concept). The reference to an element marked in this way will be duplicated, by the system, in a pre-defined branch of the tree-structure (a branch called “preferences” defined in the “administration” space, itself present, for example, in icon “1” on every user's home page). Thus at any time users can, simply by navigating in their “preferences” branch, retrieve a direct access to any element they may have discovered during their navigations.

With respect to the reception of a new element in the tree-structure, as described above, the tree-structure is dynamic and can therefore grow and be modified. Moreover, and in addition to this dynamic aspect, the tree-structure management process comprises, for each user, a dedicated navigation branch for receiving a new element (node or service). In a way conceptually similar to the branch dedicated to references of favorite elements, the nine key navigation process, in an identical space for each user, has a branch referencing elements received by each user. This allows the user to follow a simple and constant path in order to discover the new elements added to his or her space. It is noted that, as for the elements referenced in the “preferences” branch, the elements referenced in the “new” elements reception branch can be, if the user wants and when the user wants, “stored” by each user in a location he or she considers appropriate in his or her tree-structure—thus including nowhere if the element in question is uninteresting or is no longer of interest to the user; the effect of this storage is to delete the reference from the preferences or reception branch concerned.

With respect to recursivity, in the structure utilized, the model is open. An identifier and an icon are attached to each object (atomic action, navigation node or application). An atomic terminal action is a service. A sophisticated action is also a service. A tree-structure node opens a door to other nodes and/or services. A service can therefore, by extension of the model, be a sub-space, a complete branch, in which several other levels of services, several other branches, etc are then organized. By analogy with the semantics of the web, a complex service that aggregates several other services, even several branches of services, can also be called a “portal”.

With respect to a user services space and the personalization of this space, it is kept in a database of services, each of which potentially being constituted by the tree aggregation of other services. Each user then defines his or her own service space, which is the “mobilization” of a service sub-space defined for this user: a user's services space is therefore a services tree-structure, organized according to the same structural rules as the global space (thus based on matrices, recursivity, nodes, atomic actions and applications).

FIG. 5 shows that, during access to the user interface 500 of services that are the subjects of this invention via a computer (or a terminal that has a screen with a sufficient resolution), the user has a list 505 of services, represented by icons 510 and a representation 515 simulating the 3×3 matrix organization as it will be displayed on the mobile terminal during access via this mobile terminal. This representation 515 comprises pre-defined cells 520 in the 3×3 matrix. To select a service and incorporate it in the tree-structure, where it is recalled that a 3×3 matrix represents the descendants of a single node, the user first positions him- or herself in the part of the tree-structure where the icon must be inserted, using the representation 515, as if he or she was using a mobile for navigating. Then the user “drags and drops” (selection and displacement symbolized by an arrow in FIG. 5) an icon in the list 505. In other words, after placed the pointer of a pointing device, such as a mouse, on an icon 510, of the list 505, the user presses the left button of the pointing device and moves the pointer to the cell 520 of the matrix 515 where he or she wishes to see this icon, then he or she releases the left button of the pointing device. It is noted that a drop-down list (not shown) allows the user to navigate in the list 505.

As FIG. 6 shows, to submit a service to a correspondent (generally called a “friend”), the user performs the same drag-and-drop procedure from the representation 515 to a representation 610 of his or her correspondents (in FIG. 6 three correspondents are represented by the letters “A” to “C”).

The user defines this tree-structure via a web interface that makes several intuitive “construction” tools available in his or her space. Once created on the web, this tree-structure is said to be “mobile”, i.e. accessible via a mobile, thanks to the GML protocol. The user may subsequently, when he or she wishes, return to this web interface to edit his or her services space.

The base (root) of this tree-structure will be the home page of the application supporting the services on the screen of this user's mobile. The user can therefore, from this page, then navigate in his or her services space. This space is constituted by the user: the user has chosen the services that he or she wishes to access by the intermediary of his or her mobile and has organized them as he or she wants. His or her services space is not therefore the whole of the universal, or global, service space, but a sub-set, organized according to each user's wishes and needs.

The interest of this “user-centric” (and therefore filtered) view of the overall world is very different from the overall view of the Internet as given by the standard web browsers based on the WAP protocol. The importance of this filtered and “user-centric” view lies in the fundamental difference of usage behavior between a web situation (where users have a certain comfort and generally a certain amount of time, and where they expect completeness and richness in their navigation) and a mobility situation (where the users have a more limited terminal and probably a more urgent environment, and where they demand speed, ease and pertinence); this filtered view of a navigable, user-dependent global world is one of the preferential characteristics of the utilization of this invention and is based, on the one hand, on the recursive matrix organization modeled by GML and, on the other hand, on parameterization and profiling services that allow personalized profiles to be extracted.

With reference to the paragraph on recursivity, above, it is understood that a user's personal space, being constituted of a tree-structure of services, is itself a service.

With respect to intelligent cache management, from an execution point of view, this tree that represents the services space belonging to a given user is maintained in the server; its representation is sent to the mobile on request, according to the user's navigation: when the user invokes a service on his or her mobile, the system sends him or her (always via GML) the representation of his or her home page, from which he or she can navigate and invoke services. During the course of this navigation and his or her invocations, the server, via GML, sends the necessary representations (next pages of services and nodes in the tree-structure, representations of required terminal actions, etc) to the mobile. This GML transmission of representation information is dynamic and based on intelligent cache management: the system optimizes exchanges between the mobiles and the server in favor of the user experience, i.e. so as to reduce latency times during navigation. Typically, this utilizes “prefetching” algorithms (forecasting future choices) that are based on the user's usage profile and also on the structure of his or her services space: during the sending of a page representing nine services, if, in general, during his or her passage on this node the user, in more than 80% of cases, subsequently goes onto cell “4” of the next node then subsequently invokes terminal action “7”, at least two pages of this path will be preloaded (“prefetch”) during the first invocation (background preloading). If, on the other hand, the system does not know where the user is probably going to navigate, the system will, broadly, preload all (or the maximum, depending on the mobile's capabilities) of the next level's service representations.

With respect to the personalization of services, the explicit profiles and the inferred profiles, in addition to the aspect of creating a view personal to each user of the overall tree, the system also allows the final behavior, i.e. the terminal action or application that is invoked at the end of the navigation, to be adapted. Thus the terminal actions generally comprise parameters that can be chosen for the user, either explicitly by the user during the definition and optimization of his or her own space, or automatically by the system, based therefore either on preferences data indicated by the user during the definition of his or her profile, or on inferences by the system based on the user's dynamic behavior during his or her presence in his or her services space. Typically, if a user often navigates on branches or often uses terminal actions with references to “Paris”, he or she will be offered a parameterization using “Paris” if he or she navigates on a car-rental terminal action.

With respect to private branches, public branches, the dynamic evolution of a services space and navigation by successive similarities, when a user defines services (or service branches, or service portals), he or she can indicate the audience for these services.
public: everyone has access and therefore all the users of the application supporting the services can augment their own services space by referencing this service in one of the nodes or leaves of their tree-structure;
private: this service can only be navigated or used by the user or
community: this service can be referenced (and therefore navigated or used) by a set or sets of users designated by the creator of the service.

Beyond the virtue of sharing, this possibility gives a significant dynamic characteristic to the services space and its navigation: a user can reference, in his or her own space, a public portion of another user's space, which can be enriched, with the other user adding branches or services that, by transitivity, are also added in the first user's navigable space. One user can also, in their turn, reference a public or community portion of a third, etc. Step by step, the spaces can therefore have an intersection with or “cross-pollinate” each other TN, enabling navigation by successive similarities in a living, dynamic and open space, while remaining controlled and always user-centric.

With respect to promoting services, as has been seen, a user's space is a tree-structure, with its public or private branches, chosen and/or defined by the user through a web interface. This tree-structure becomes navigable via his or her mobile and, in its leaves, leads to a collection of services. The fact that some of its branches are references to other public branches creates a first level of dynamism in the structure of this user's space, since the public branches referenced can change.

A second level of dynamism is offered by the mechanism known as “InGoojet”: in every space of every user, a branch is reserved by the system supporting the implementation of this invention, for dynamically adding services available to this user: this is an extension to the mailbox concept, but structured for references to services. This reserved branch is structured lineally: in the first page, it only contains two representations of services: an “empty” service, which is a place reserved for the first service that will be sent to this user (empty service known as a “place holder”) and a second service forming a node that simply leads, in a second page, to a page structured in the same way as the first (this node is therefore a “next” service), and so on, recursively, as required. This allows the user to simply navigate lineally in this branch, whose size varies dynamically according to the services he or she receives in it.

Services can be sent to users by promotional activities: on the website or via his or her mobile, a user can decide to share services with another user or a user community and thus promote this service, whose reference will then be dynamically added by the server to the representations of the tree-structures of each recipient, at the end of the “InGoojet” branch. Each user therefore immediately has access to a new service. He or she can, if wished, make it disappear from his or her “InGoojet” branch; he or she can also, via the web interface, reorganize his or her services space and put this service, if he or she wants to keep it, in another place in his or her own services space.

In addition to its use in the context of promoting or exchanging services, this dynamic “InGoojet” branch is also used directly by the user if he or she wants to add the access to a service in his or her services space without, necessarily, having access to a web interface (which is, as described above, the standard method of creating and managing a services space). This need can be ad hoc and urgent: the system therefore makes available to the user, via his or her mobile interface and in addition to the web interface, a special service called “Goojet Picker” that allows the user to select a service in the services database by entering its unique identifier. The reference of the service selected in this way will be added in the user's “InGoojet”, in the same way as a service received by promotion from a third-party.

The fundamental concept associated to this capability for promotion or visibility of a “goojet picker” service is the installation of a services directory belonging to the system implementing this invention. In other words, the system defines the GRL (acronym for “Goojet Resource Link”). The GRL is a multimodal identifier that enables access to a service that is both mobile and web-only. On the Web, the GRL has its origins in the URL concept (www.goojet.com). On the mobile, this gives access directly to a set of resources/applications authenticated by the organization managing the services that are the subjects of this invention and represented on an icon which can be located in different tree-structures according to the mobiles referencing it but which still reference the same unique resource.

When a user creates a service, it is assigned a unique identifier (GRL). This identifier reserves a unique entry in the services directory for it. The server gives access to information concerning the ownership of the service, through a mechanism of “Whols”.

An example that illustrates the benefits of the mechanism is that of a “Restaurant” service. With the services platform, an application can be created that allows the user to find out information about a restaurant (location, menus, prices, contact details) and at the same time book a table at this restaurant. While it is possible for anybody, without guarantee of uniqueness on the part of the platform, to create a “Restaurant” service, the user can find himself with a major inconsistency in mobility situations (booking a table at a restaurant that is not the one expected).

In a similar way to “InGoojet”, the system makes a third level of dynamism available to the user: the “bookmark”. The bookmark is a linear structure similar in every way to “InGoojet” in which the services that the user wants to make immediately available are added dynamically. The bookmark is especially useful when the user navigates an unknown branch of the space (typically a public branch which he or she accessed by successive public navigations) and finds an interesting service there. Bookmarking, during his or her visit, sends the reference into “InGoojet” for immediate access and possible subsequent reorganization when the user uses the web interface.

With respect to the creation of services, the system allows the user to create his or her own mobile space by selecting and aggregating atomic actions, services, service branches or public spaces together into a suitable tree-structure organization. Using these same selection, parameterization and aggregation mechanisms, the user can also create services (or sub-sets of services) not necessarily in order to reference them in his or her own space, but to make them available to other users. In this way, the system offers a user the new capability, by aggregating and parameterizing already existing elements, of creating new services, which will be available to other mobile users, without having to develop computer code or having to distribute, by any channel whatsoever, mobile applications. The global services space is therefore open for navigation and is also open for contribution, and frees the user from steps considered complex relating, if this invention is not utilized, to the creation, distribution and exploitation of mobile applications.

With respect to the explicit communities and inferred communities, in the same way as user profiles can be explicit or inferred, communities (for declaring access rights to branches, for promotions of services, etc) can be:
explicit, i.e. defined by explicit lists of user identifiers or mobile telephone numbers,
inferred, i.e. calculated in real time by the system based on usage and behavior statistics. Typically such an inference uses a calculation of the semantic distance between the users: based on the type of navigation and the type of services used, the system dynamically identifies communities of use (sports people who live in Paris, teenagers who like rock ‘n’ roll, etc). These inferred communities are used for the pertinent promotion of services, for various community services (for example, searching for a tennis partner, a car-sharing service, etc) and to make it possible, during sales operations by commercial partners, to pertinently reach the optimum public for their messages and promotions. The server therefore carries out the constant acquisition of data on all the users and all the services in order to feed profiling algorithms, whose results are then used for personalizing services and services spaces and for the pertinent sending of information or services. This capability is one of the pillars of the system's commercial exploitation.

With respect to web-mobile ubiquity, the services defined on the infrastructure utilized are intended to be referenced in tree-structures accessible via mobiles so as to offer services in mobility situations. But the structure of these services also makes them accessible through the Internet (via a web browser). That allows users to share information, data and services regardless of their means of access. In addition, the system recognizes the means of access to a service and offers a different level of richness according to the means of access used. For example, the server supporting a voting application just displays the current result of the vote for a mobile access, whereas it offers a large variety of historical and statistical analyses for a web access.

FIG. 7 represents, schematically, a unified communications infrastructure 701, also called a “UCI”. This infrastructure makes it possible to process four standard message flow types (IM for “instant messaging”, SMS, electronic mail and voice communication), and also flows supplied by a proprietary community platform. The UCI infrastructure supplies gateways between these types of flows (incoming/outgoing).

The infrastructure comprises:
a gateway 702 to and from voice transmission services, especially over the Internet,
a gateway 703, to and from SMS short message services,
a gateway 704, to and from electronic mail servers,
the server 705 holding the software and data for utilizing this invention and supporting the infrastructure 701, and
a gateway 706, to and from instant messaging services,

In embodiments, the UCI 701 manages a conditional routing (a function known under the name “forwarding”) according to:
the identity of the sender of the message,
a given period (time, date, etc),
content elements and/or
a presence signal (if the recipient is identified as present on one of the channels configured in the routing, the message is first of all or only sent on that channel).

The UCI can also manage a routing workflow. This means that there is a level of emission priority for each channel and a wait time between each emission. This function avoids duplicating the content of the message if the user considers that as soon as it has been acknowledged, he or she does not want to see it on another medium.

The UCI can enable the management (creation/modification/deletion) of all or part of applications as described in the description of the creation of full-featured applications on the fly.

The UCI 701 thus carries out, in a routing server, as illustrated in FIG. 9:
a step 910 of receiving data to be transmitted, said data being associated to an identifier of the recipient,
a step 915 of determining a context for transmitting data to the recipient,
a step 920 of selecting at least one reception channel associated to said recipient according to said context and
a step 925 of transmitting data on each reception channel selected.

In this way the channel, or channels, used to transmit the data to the recipient varies according to the context.

During the step 915, the routing context is representative of:
an identifier (unique address on a channel, electronic address, electronic mail address, telephone number, for example) of the sender of the data to be transmitted,
a time-stamp of the data to be transmitted, for example the hour and minute they were received by the server,
the content of the data to be transmitted,
an access to a channel available for the user (i.e. information, for each channel, that the user is connected to the medium for this channel), and/or
a priority for channels.

Thus, for example:
the user can request that the data from at least one contact is sent to him or her on a pre-defined channel or on all the channels allowing data transmission, for example,
conversely, the authorities or a line manager of the recipient can order things so that any datum from them is transmitted by all the reception channels associated to the user,
the user can request that the data coming to him or her during office hours are transmitted on a pre-defined channel while the same data arriving outside office hours will be sent to him or her on another pre-defined channel,
the user can request that the data from a message comprising a specific reference (for example a file number) are sent to him or her on a pre-defined channel,
when the user does not have access to the mobile telephone network, for example, he or she can request that the data is sent to him or her on a fixed line, and/or
the user can request that a message's data are sent to him or her on a first pre-defined channel, that if he or she does not confirm reception in a pre-defined length of time, the data will be transmitted to him or her on a second pre-defined channel, and so on. In this way, the user avoids duplicating the content of the message on different channels while optimizing the chances of the data being received quickly by the user.

In embodiments, during the selection step, a table is utilized correlating parameter values of the context and data transmission channels. Thus selection is easy and the correlation table can be easily edited by the user.

In embodiments, during the data transmission step, data is formatted according to the transmission channel on which the data are transmitted, as described below. In this way, one can easily switch from voice to text, or vice versa, from electronic mail to a short message, or vice versa, etc.

In embodiments, during the transmission step an application program is created based on the data to be transmitted and the application program is transmitted to the user.

In the particular embodiment described with reference to FIG. 7, the UCI infrastructure carries out the following operations:
the UCI 701 receives a message from a gateway 702, 703, 704 or 706, or the server 705;
the UCI 701 analyses the message content according to the sender in order to extract structural elements;
for each recipient of the message:
   the UCI 701 determines, in the conversion table, the transmissions to be carried out and
   the UCI 701 sends the message for each channel configured according to a set of (conditional) management rules.

The association of labels or “Tags” to the incoming flows allows the platform's behavior to be enriched during the creation of outgoing flows. The infrastructure allows all types of media to be output by using formatting capabilities adapted to the media. The senders or recipients of media considered are, in particular:
a computer via:
   a web browser on a dedicated URL,
   an e-mail client on a dedicated account,
   an IM client and
   a dedicated application on a proprietary format and
a telephone via:
   the SMS client,
   a dedicated application,
   a “WAP” navigator and
   a voice mailbox.

The UCI is configured by each user to define the gateways that he or she wants to parameterize. The following table gives a presentation of different flows.

When configuring the UCI, the user gives details of:
the IM accounts used,
for SMS, the telephone number,
for electronic mail, the e-mail address,
for voice communications, the telephone number and
for using the platform implementing the services that are the subjects of this invention, an account identifier.

The following table references, by numbers between “1” and “20”, flow conversion requirements:

| | Receiving | | | | |
|---|---|---|---|---|---|
| Sending | IM | SMS | E-mail | Voice | Platform |
| IM | x | 1 | 2 | 3 | 4 |
| SMS | 5 | x | 6 | 7 | 8 |
| E-mail | 9 | 10 | X | 11 | 12 |
| Voice | 13 | 14 | 15 | x | 16 |
| Platform | 17 | 18 | 19 | 20 | x |

This table summarizes the different types of messages output and input. That means that the numbers appearing in the various cells will be used to identify the processing carried out by the infrastructure in each of the cases. The “x” in the diagonal of the table means that, in theory, no processing is needed.

Sending an SMS: when an SMS is received by the UCI, each item of text terminated by the “©” symbol is analyzed as being a recipient. For example, the message “D1@ D2@ hello how are you?” will be processed as the message “hello how are you?” sent to the UCI for recipients D1 and D2.

The UCI carries out the following processing:

Case 1 (the recipient has configured one or more IM channels via which he or she wishes to be notified): the entire SMS (except for the recipient fields) is transmitted via IM with the sender's identity

Case 10 (the recipient has configured an e-mail address via which he or she wishes to be notified): the entire SMS (except for the recipient fields) and the sender's identity are incorporated into the body of the e-mail. The subject contains “the platform informs you that an SMS has been received”

Case 14 (the recipient has configured a voice mailbox): the entire SMS (except for the recipient fields), and also the sender's identity, is converted by a “TextTOSpeach” process. The UCI makes a voice call for each recipient of the message.

Case 18 (the recipient has subscribed to a community platform): the entire SMS is transmitted to the platform for analysis. The processing of the recipient fields is carried out on the platform (the recipients' Identifiers can be different from those known by the UCI).

Sending electronic mail: when electronic mail is sent to the address of the “recipient” by means of the unified messagery infrastructure, it is analyzed according to the following cases:

Case 2 (the recipient has configured one or more IM channels via which he or she wishes to be notified): the electronic mail's subject is transmitted via IM first, with the sender's identity. The text content is extracted from the body of the electronic mail and formatted in order to be transmitted via IM.

Case 6 (the recipient has configured the SMS channel): the subject of the e-mail is transmitted in the body of the SMS, together with the sender's identity.

Case 15 (the recipient has configured a voice mailbox): the subject of the e-mail is converted by a “TextTOSpeach” process, and also the sender's identity.

Case 19 (the recipient has subscribed to a community platform): the entire e-mail is analyzed as follows:
subject: the subject can contain a “tag” giving a business character to the message (for example: “[ALARM] break-in at the recipient” will result in the platform being contacted with the tag ALARM so as to generate a behavior dedicated to processing an alarm). If the platform does not know how to interpret the “tag”, it uses the default behavior:
attached items: each attached item is analyzed in order to define the type of document and thus enable the platform to perform a transformation on the source to adapt it to the platform's capabilities;
body of the message: the body of the message can contain tags making it possible to direct the platform with respect to the processing of the message body generally complementing the Tag contained in the subject.

Sending a voice call: when a voice call is received by the UCI, the message is recorded then the UCI asks for the identifiers of the message's recipients to be entered. The Identifiers can be Identifiers pre-recorded on the UCI and associated to the caller's number. For example: a user with the telephone number “0607080910” has pre-defined the recipients D1 and D2, giving them the identifiers “1” and “2”. When this user calls the UCI from his or her mobile, the UCI identifies the caller number and at the end of the voice message, if the user enters #1#2#, the UCI will send the message to recipients D1 and D2.

The UCI will carry out the following processing:

Case 3 (the recipient has configured one or more IM channels via which he or she wishes to be notified): the following message is published via IM: “The person on number xxxx has left you a voice message”.

Case 7 (the recipient has configured the SMS channel): the following message is sent via SMS: “The person on number xxxx has left you a voice message”.

Case 11 (the recipient has configured an e-mail address via which he or she wishes to be notified): the voice message is sent as an attachment to the e-mail. The subject contains “the platform informs you that a voice message left by xxxxx has been received”.

Case 20 (the recipient has subscribed to a community platform): the voice message is transmitted to the platform together with the Ids entered at the end of the message.

Sending via the platform: when the platform sends a message to the UCI, it pre-processes the message for the different categories of flows that exist. The UCI receives formatted data that can be directly transmitted:

Case 4 (the recipient has configured one or more IM channels via which he or she wishes to be notified): text destined for IM.

Case 8 (the recipient has configured the SMS channel): text destined for sending an SMS.

Case 12 (the recipient has configured a voice mailbox): voice message destined to be left on the voice mailbox.

Case 16 (the recipient has configured an e-mail address via which he or she wishes to be notified): the entire e-mail is prepared:
subject,
attached items and
body of the message.

The UCI can optionally manage a conditional routing (a function known under the name “forwarding”) according to:
the identity of the sender of the message,
a given period (time, date, etc),
content elements and/or
a presence signal (if the recipient is identified as present on one of the channels configured in the routing, the message is first of all or only sent on that channel).

The UCI can also manage a routing workflow. This means that there is a level of emission priority for each channel and a wait time between each emission. This function avoids duplicating the content of the message if the user considers that as soon as it has been acknowledged, he or she does not want to see it on another medium.

The UCI can enable the management (creation/modification/deletion) of all or part of applications as described in the description of the creation of full-featured applications on the fly, below.

In the rest of this description, additional descriptive elements are given on the architecture of an embodiment of the system implementing this invention and on the services that are the subjects of this invention.

In order to notify the user of the occurrence of an event related to a service, “pings” or “signals” are sent with the help of telephone lines. A call utilizing a pre-defined caller number is briefly sent to the user (who does not answer the phone) to notify him or her of an event (new message, new update, etc), the pre-defined number serving as an identifier of the event. After receiving this short call, the user just needs to connect to the server.

In a service, users can import all or part of another person's services space into their space. This makes the concept of sharing information and services transparent. For this purpose, the level of visibility assigned to each of the other user's services is used, somewhat similar to what can be done on “Flickr” with images (public/friends/family), and the user cannot perform an action (for example a reservation) in place of a person because the user has imported his or her space into his. Moreover, addition into the “buddy-list” should be subject to authorization (as in most systems).

Data partitioning controlled by social proximity: in very large volume systems one database is not enough to store all the data, and partitioning is necessary, i.e. having databases that only contain a part of the users. Standard approaches are simply based on a modulo of a unique identifier (of the type user-id % nb-machines) or a balancing of the volume of data.

In embodiments of the system implementing this invention, the efficiency of the system is improved by keeping users with strong links on a single server. The partitioning is therefore controlled by the connectivity of graphs. This does not hinder the geographical distribution of data, since a related graph of users can be stored in a datacenter located in a location in the centre of this graph.

This invention allows the creation of full-featured applications on the fly by the use of different media. For example, it involves creating an application from the reception of an electronic mail, by analyzing the sender and, if he or she is known, in order to go into his or her account, the electronic mail's subject, body and attachment(s) being transformed into a computer application. For example, an electronic mail bearing attached photos becomes a photo album application with, as title, the subject of the electronic mail. In another example, an electronic mail having as subject, according to a specific syntax, the date/time and place of a meeting is transformed in a calendar application of an event for the date/time with, as title, the place of the meeting and, as description, the body of the e-mail.

In the preceding examples, only the electronic mail medium has been considered. However, a large number of other media can also be handled, for example the following media:
SMS,
MMS,
IM,
telephone (electronic representation of a telephone call: sound file),
fax (electronic representation of the fax: tiff, pdf, etc) and
Web UL (HTML, XHTML, etc).

More generally, all electronic sources (textual, sound, images whatever the formats with syndication or not of the sources (text+image, only text, etc)) are input sources for creating a full-featured application using some or all of the content.

“Full-featured application” refers to any application already existing complete, partial, generated on the fly, proprietary or not.

With respect to the identification of the user, in most cases, identifying the user may/must be required in order to allow this new application to be added to his/her account.

In most of the media sources proposed above, there are means of automatically identifying users without adding this information to the rest of the content: caller number, identifier or user name, etc.

The process makes it possible to manage all or part of full-featured applications by sending, submitting or retrieving any document (single or multiple) in the formats listed below (the lists of format and types of format are not exhaustive) by means of any possible medium (telephone, e-mail, IM, Fax, etc).

Sound file formats: RAW, WAV, MP3 (MPEG-1 Layer III), XAC, AIFF, AIFC, IFF, AU, VOC, SND, Ogg Vorbis (or OGG), AAC or MPEG-2 AAC, MP3pro, VQF or TwinVQ (acronym for “Transform-domain Weighted Interleave Vector Quantization”), WMA (acronym for “Windows Media Audio”, registered trademark), ASF (acronym for “Advanced Streaming Format”), SDS, SMP, VOX, MAT and FLAC.

Image formats: JPEG, GIF, TIFF, APNG, MNG, PNG, PCX, BMP, Silicon Graphics IRIS, Raster SUN, PPM, Postscript encapsulated, Pixmap X, photoshop, PGM, DICOM, Bitmap X, Alias|Wavefront PIX.

Video formats: Divx, QuickTime, Real, Xvid, VP7, X264, AAC, Ogg Vorbis.

Text document formats: Doc, Docx, Odt, Sxw, Rtf, Sdw, Pdf, Txt, XML, HTML and XHTML.

As shown in FIG. 11, for creating computer applications, from the reception of a message that has a content, step 1105, a type of computer application likely to be associated to said content is determined according to said content, step 1110, and a generic application of the type of application determined with said content is parameterized in order to constitute said computer application, step 1115.

When determining a type of computer application, the type of computer application depends on:
the identity of the sender of said message,
at least one attachment of said message and/or
key words included in the content of said message.

With respect to navigation on the web, this invention also concerns a web navigator developed for mobiles with limited capability. In effect, the web's success is due, in part, to the fact that the HTML (page description language) and Javascript (dynamic web page programming language) are supplied to the navigators by the web servers in the form of source text. This has, firstly, avoided having to define binary representations that may be dependent upon a platform and, secondly, has meant that any user can learn to develop web pages simply by examining their source code.

But this imposes a heavy workload on the navigator, which must analyze the source code of the HTML and Javascript before it can, respectively, display them and execute them. This is not a constraint for modern personal computers with large computing power, large storage capacity and quick network connection, but it becomes a problem in restricted environments such as entry-level or mid-range mobile telephones.

To enable mobile telephones with limited capability to display HTML web pages, and also execute Javascript code, these elements are pre-analyzed in a gateway between the telephone and the website. In addition the capability is also proposed, offered to the Javascript code contained in the web page, of using what are known as “native” functions of the telephone, such as sending SMS, establishing communications or capturing images. A mechanism is also proposed allowing the same Javascript code to be used to obtain similar functions on the browser of a personal computer.

The navigator created in this way is able, in addition to or in replacement of the GML, of receiving HTML and Javascript code in a special binary format, allowing its use on any type of mobile. The binarization (transformation into binary digits) is carried out by a server called a “gateway server” 840 (see FIG. 8). To access a web server 880, the navigator 820 on mobile 810 sends a request 890a to this gateway server 840, which sends it, by message 890b, to the actual server 880. This actual server supplies the web page and its Javascript code, by messages 805. The gateway server 840 carries out the binarization/compilation process and sends the result of this process, by message 815, to the Goojet navigator of the mobile telephone 820.

The binarization comprises several actions (the actual order can be different from the order presented below) carried out by the gateway server:
expanding the CSS styles 850, defining the appearance (size, font, color) of each element of the HTML page,
transcoding the HTML elements 860 into a binary representation that can be used effectively by the mobile telephone,
compiling the Javascript code 870 into a compact “bytecode” that can be interpreted effectively by the mobile telephone

An optional characteristic of the navigation process is that the transformation is totally transparent for the Javascript code contained in the page. In particular, the latter can modify the structure of the page after it has been displayed on the mobile terminal 810. The DOM “Document Object Model” interface is available to enable the construction of interactions local to the terminal not involving the original server.

Another optional characteristic is that the result of the transformations can be stored by the gateway server 840 in a temporary storage system 825 so that the transformation of the same content that may be requested frequently, either by the same mobile telephone or by other telephones, is not carried out repetitively.

Using Native Functions of the Telephone

The environment in which the Javascript code is executed in the telephone comprises special functions allowing the mobile's native function and peripherals 830 to be used. In particular, and in a non-limiting way:
sending SMS,
establishing telephone connections,
consulting the address book and
using the camera integrated into the telephone to capture still pictures or videos.

As the present invention aims to provide a transparent execution environment for the applications, these functions will also be available on a navigator working on a personal computer.

For this purpose, the execution environment on a personal computer provides the web pages with a Javascript operating environment comprising an implementation of these functions. The means used will be, in a non-limiting way:
a web/SMS gateway for sending SMS,
using telephones utilizing SIP or Skype (registered trademarks) software for establishing telephone connections,
consulting the address book downloaded from the telephone and synchronized with the server,
using a navigator extension, of the “Flash Plugin” type, for using a webcam or other photographic pr video device connected to the computer.

For this purpose, a pre-analysis is carried out on the gateway server of the formatting characteristics of the HTML content (CSS styles) on the server, the HTML and its formatting are transformed on the gateway server into a compact binary form and the Javascript is compiled on the gateway server into directly executable “bytecode” instructions.

This thus ensures transparency of the binarization/compilation process for the Javascript content of the web pages, the availability to the Javascript of functions accessing the telephone's native functions and the implementation of the telephone's native functions for navigators on personal computers with the help of telephone software and a webcam or other photography and video capture peripheral.

FIG. 12 shows steps utilized to transform a web page with a view to displaying it on a communicating mobile terminal.

During a step 1205, the communicating mobile terminal sends, to a gateway server, a request identifying the page to be displayed. During a step 1210, the gateway server sends a request identifying said page to the server hosting said page. During a step 1215, the gateway server receives the web page comprising an HTML content and Javascript.

During a step 1220, the gateway server pre-analyses the formatting characteristics of the HTML content of said page.

During a step 1225, the gateway server transforms the HTML content and its formatting into a compact binary form. For preference, during the step 1225 of transformation into a binary format, a step is carried out expanding CSS styles of the page's HTML content defining the appearance of elements of the page's HTML content transformation into a binary format, and the page's DOM (acronym for “Document Object Model”) interface is kept accessible.

During a step 1230, the gateway server compiles said page's Javascript into instructions directly executable by the communicating mobile terminal. For preference, during the compilation step 1230, the page's Javascript is compiled into “bytecode” instructions directly executable by the communicating mobile terminal.

During a step 1235, the gateway server associates Javascript code contained in the page and at least one native function of the mobile telephony part of the communicating mobile terminal.

During a step 1240, the gateway server supplies the communicating mobile terminal with the compact binary form of the HTML content, instructions from the Javascript compilation and elements of association to native mobile telephony functions.

FIG. 13 shows steps utilized to transform a web page with a view to rapidly displaying hypertext links on a communicating mobile terminal.

During a step 1305, the terminal sends a request to a remote server hosting a website to access a page of this site, in a manner known per se, for example after the terminal's user has entered an electronic address (“URL”) or by selecting (“clicking”) a link in a computer application or on another web page.

During a step 1310, the server starts to send the content of the required page. This content is described, for example, in the form of HTML or XTML code, animations, images, sound file and/or video file.

During a step 1315, during the reception of the page content, the terminal detects, in the page content already received, and extracts at least one hypertext link, according to known techniques.

During a step 1320, the terminal detects whether a graphic, possibly animated, is associated in the page content to the hypertext link extracted. For preference, during step 1320, the terminal only considers a low-resolution graphic. The association sought can be of a known type, i.e. a selection of the graphic (“click”) initiates a request on the associated link, or a type dedicated to the utilization of this invention, for example in the form of a list of hypertext links and graphics in front of the content data of the page being received. If a graphic is associated, in the page content, to the link being processed, step 1335 is proceeded to.

If no graphic is associated, in the page content, to the link being processed, during a step 1325 the terminal determines whether there is a graphic in memory to be associated to the link. For example, a link containing the word “home” is automatically associated to a graphic representing a house. If such a graphic exists, step 1335 is proceeded to.

If not, during a step 1330, a part of the link's electronic address is determined in order to extract from it words from a dictionary, preferably multi-lingual. Thus, amongst others, the first letters of this address (for example, “http://www.”) and the last letters of this address (for example, “.html” or symbols linked to dynamic addresses) are removed. For preference, during step 1330, the most identifying portion (or the dictionary word) of the link address is looked for. For example, if several links have the same beginning, this beginning is not considered to be an identifier. On the other hand, if all the extracted dictionary words are identical for two links, differentiating symbols are added coming from addresses initially extracted. The parts considered to be identifiers are then represented in larger characters than the other parts of the address in order to create an alphanumeric graphic enabling the user to recognize each link easily. Then step 1335 is proceeded to.

For preference, the graphics from steps 1320, 1325 and 1330 are standardized in dimensions. For preference, these dimensions are adapted to the resolution of the terminal's display screen. For example, the aim is that nine graphics associated to the links can be displayed on the terminal's screen so as to correspond to the numeric keys of the terminal's keypad, as described above.

During a step 1335, the graphics are positioned in a page corresponding to the terminal's screen. For preference, the positions are determined according to positions of links in the original page being received. In this way, a link that is farther to the right than another, in the original page, remains farther to the right in the page generated during step 1335.

Then, during a step 1340, the page generated during step 1335 is displayed on the terminal's screen. Thus, even before the entire content of the page has been received, the user already has links allowing him or her to navigate to other pages or animations. Thus he or she does not have to wait until the page has finished loading to go to another page. The user therefore saves time, especially when he or she knows the page being loaded and does not want to see it.

During a step 1345, it is determined whether the terminal's user has selected one of the links, via its graphic, with the utilization of a touch-screen or numeric keypad, as explained above.

If yes, the terminal goes back to step 1305 to send a request to receive the content associated to the link selected or, where appropriate, launch the application associated to this link. If no, during a step 1350, it is determined whether all of the links of the page being received have been processed. If not, step 1310 is returned to. If yes, during a step 1355, it is determined whether all the content of the page has been received. If not, step 1315 is returned to. If yes, during a step 1360, a graphic is generated representing the page received and it is inserted into the page displayed on the terminal's screen. In this way the user is given access to the display of the page received, while keeping the display of links extracted from the page content. For preference, the graphic representation of the received page is dedicated. For example, it is uniform and represents the term “page” or a miniaturized (and therefore unreadable) standard page.

The graphic representation of links is more intuitive than the display of the link itself and can be standardized in dimensions, graphic chart, etc. In particular, a site can provide graphic representations to be displayed, in front of the page content, in order to help users that have terminals with limited capability for receiving, displaying and/or processing contents. For preference, the graphic representation is automatically adapted to the terminal and/or the page being received, for example, according to the resolution of the display screen so that the number of links represented is constant or increases with this resolution, according to the reception speed for the page or according to an estimated time for receiving the page so that a terminal with high capabilities of reception, display and processing does not display extracted links but waits for the page to finish loading before displaying it while, in contrast, a terminal with more limited capabilities uses the extracted links and their display to quickly give the user means of navigating from the page being received. For example, the limit value of the length of time, after which the links are extracted and displayed, is one second. It is noted that, in order to utilize this variant, there is an intermediary step 1312 between step 1310 and step 1315 determining the reception speed and/or the estimated length of time for this reception and comparing this speed and/or length of time with a pre-defined limit value.

With respect to the services that are the subjects of this invention, the infrastructure utilized allows innovative services to be developed, promoted and used, examples of which are presented below:

1/ synchronous “conference call” service on request: this service makes it possible to put several remote users into contact simultaneously, via their mobile telephones, without having had to prepare or book a conference. This service is especially practical in mobility situations or when contacts are dispersed. This service allows a user to select contacts for a telephone conference, either by explicitly entering mobile identifiers or by the system automatically entering the identifiers (by interpreting the contacts list in the page from which the service is invoked). Simply by invoking the terminal action “conference call”, selected in the user's services space, leads to the server sending notifications to the candidates inviting them to a conference. These notifications can be multimodal and comprise, amongst others, an SMS and a notification via the service interface (GML response to a polling). When the notification is received, each recipient can, simply by accepting, be put directly into contact with the server organizing the conference. The mobile portion of this service consists of selecting candidates and managing the notification (initiation on the user's side, acceptance on the invited person's side). The server's task thus basically consists of sending notifications and connecting each recipient following their acceptance. In addition to this function, this conference application's server also offers added value conference management functions, such as recordings and/or statistics, whose use is available via the web interface.

Each potential contact, or candidate, receives a call number and a graphical interface indicating the contacts whose telephone numbers are being dialed (action of calling the number and ringing on the active number). The system reserves the number for the conference since, knowing the number of potential callers, it can filter out unwanted people who may call the number at the same time. The leader of the conference can decide, with a simple click, to switch everyone to conference mode (the start of billing for each caller).

When a user is invited to a conference, he or she has a trigger. Selecting, or “clicking”, on this trigger brings up a page with the avatars of the people invited to the telephone conference (if a person is not identified, his or her name or telephone number is shown). A status is represented next to or over each avatar's icon and indicates whether the corresponding user has joined the telephone conference. In an option, the status identifies the person who is speaking. For preference, the server does not take a contact's call unless there is at least one other participant calling. This avoids a user being connected for nothing.

FIG. 10 illustrates a particular embodiment of the process implementing this “conference call” application. In the description the terms user and contact are equivalent and are used indifferently. First of all, FIG. 10 shows a step 1005 of initiating the communication, by a first user, during which the first user selects an application in a tree-structure, with his or her mobile telephone, as described above.

Then, during a step 1010, a selection is made, by said first user, of at least two users known as “second users”. This selection can be carried out:
second contact by second contact, by entering their telephone numbers or by selecting this number in a directory or by selecting avatars or photos representing them and/or
by selecting an application in which a set of potential second contacts is also listed (possibly with removal of potential contacts).

After the first contact confirms the list of second contacts invited to the conference, a server implementing the conference service receives this list from the first contact, during a step 1015, and reserves a number assigned to said conference.

During a step 1020, the server notifies each selected second user during which each second user receives information from a graphical interface representing the first user and each other second user selected and also the reserved number.

For the notification step, the server can utilize different types of communication channels with the different second users. In addition, the notifications can be multimodal, according to the second contacts' communications capabilities.

For preference, during the notification step, if there is no response from a second user, said absent second user is notified again by means of a different communication channel from the one used for the first notification of the absent second user. Thus, a contact who has not responded via a mobile telephone can be called on a fixed telephone, for example.

During a step 1025, each second user terminal with the conference application displays said graphical interface.

During a step 1030, the server determines whether a second contact has accepted participation in the conference. To accept, each second user just has to select an acceptance icon represented on the graphical interface. Otherwise, during a step 1035, the server determines whether a second contact has refused participation in the conference. To refuse, each second user just has to select a refusal icon represented on the graphical interface. If not, step 1030 is returned to. If the result of step 1035 is positive, during a step 1040, information is sent to each contact, first or second, representing the second contact's refusal to participate, as well as the identification of this second contact, and step 1025 is returned to.

If the result of step 1030 is positive, during a step 1045, information is sent to each contact, first or second, representing the acceptance of participation by the second contact, as well as the identification of this second contact, and each graphical interface displays this information. Then, during a step 1050, it is determined whether the first contact is initiating the conference. To initiate the conference the first contact just has to select an icon in the graphical interface. If not, step 1030 is returned to. If yes, during a step 1055, the first contact and each second contact who has accepted to participate in the conference receives the number reserved for the conference and, possibly after a final confirmation by the second contacts, all the mobiles of the contacts who have accepted the conference are put into telephone or videophone, for those with videophone means, contact by means of the reserved number.

During a step 1060, if the first user has selected a recording option, and for each second contact having subsequently accepted to participate in the conference, authorization to record is requested from each second contact participating in the conference. If there is authorization, during a step 1065, the conference content is recorded and, at the end of the conference, step 1075, a step 1080 is carried out making said recording available to each of the conference's participants, for example by sending an audio and/or video file to the electronic addresses of the participants. During the conference, step 1070, the contact speaking is detected (by simply processing the audio signal of the various participants), and this leads to an identification of the user speaking being displayed on the graphical interfaces of the various participants. Following the conference is therefore made easier.

It is noted that if there is a call for the first user between steps 1005 and 1070, this call is rejected. In this way one avoids having a third party, who has not been invited to the conference, disrupting the proceedings.

In a variant, in place of step 1050, the connection is triggered automatically when at least one second user has accepted the conference. This thus avoids the first user being billed for the call while waiting for the conference to be accepted by the second users.

The notifications indicated above can be made by short message (SMS), short multimedia message (MMS), voice call with voice message, voice call then hanging up, electronic mail, message in the conference application or any other compatible or connected application.

2/ autonomous web-mobile transactional services: in this service, the server manages transactions between customers and suppliers and can therefore, in certain cases, replace fat computer or Internet services. These services are made possible through the intelligent breakdown of processing between server and mobile presentation. For example, the reservation service is defined as follows:
the supplier, for example a restaurant, creates its service—this service is a branch of various aggregated services, including information about the restaurant, links to other services considered by the restaurant to be relevant or related. One of the leaves of the tree-structure is the reservation application service, parameterized by the restaurant for its needs, when its transactional service is created. Once created, this complex service that includes the reservation application service parameterized for this restaurant is available for this invention's community of users. Public, it can be promoted. Thus it can be in the spaces of potential users without them having to search for this service.

The reservation application service comprises several pages for entering selections (each selection entry page being a parameterizable atom), which, together, form the elements of a request. For example, the user chooses a time and a number of people (the same concept applying, of course, to any type of request, the number of successive selections and the candidates for each of these selections being parameters entered by the creator of the service when it is created). Then he or she sends his or her request, which the server receives and processes. The server's processing consists of sending the request to the restaurant in the format chosen by the restaurant when creating its reservation service. The restaurant can select a multimodal notification: for example by SMS, electronic mail, telephone call, invocation of a web service with its computerized management system, the content of which is produced by the server according to the parameters sent by the customer's mobile portion during his or her request. Among the many possible modes, one is also a service: the restaurant can have the “supplier” mobile portion of the same service. This service is structured, in effect, into a “customer” mobile portion, used by each of the restaurant's customers to send their request, a server to process the requests, and a “supplier” mobile portion that completes the transaction. With this service, the restaurant can therefore receive the request directly in the application space and process the request almost in real-time, via its mobile: on acceptance or refusal, it completes the transaction via the server through to the sender of the request. It can also use its “supplier” mobile portion for management operations (for example, displaying “full” for future users). It can also, by using a web access to the server, have access to greater richness on this service, including various statistics on use of the service, information on the requestors, etc. Thanks to its distributed structure and thanks to its bimodal web-mobile access this service, of a new type, replaces both a voice reservation service and a standard information and management system. The transactional reservation service, based on a complementary pair of mobile portions, one for the customer and one for the supplier, and on a mediation and management service, is new.

3/ interaction service between the real world and the virtual world: this concerns making it possible to enter a virtual world with the communication tools of the real world (telephone connection, access to an instant message service, such as “IM”, registered trademark, or electronic mail, or “e-mail”). The innovation lies in the fact that two avatars can be connected together hiding their identity in real life. Taking the avatar's profile into account is integrated into the use of a voice filter, for example a filter transposing voice frequencies into higher tones for the voice of a man who has chosen a female avatar.

For utilizing this interaction service between the real world and the virtual world:
the platform utilized by the server allows the identities of each user to be referenced in different environments or virtual worlds,
the platform receives and processes messages coming from different virtual worlds and
for each identity recognized, the platform routes messages to the channel that is suitable/configured by the user (owner of the identifier).

For example, in virtual world VW1, user U1 has identifier u1 and a person U2 in this virtual world VW1 has identifier u2.
u1 calls u2 using the VW1 service,
the application supporting the interaction service makes a request for u1 and u2 to be connected in world VW1 (without knowing U2's real identity),
the interaction service obtains U2's contact details,
the interaction service sends the request to the UCI (see FIG. 7), which carries out all the actions associated to U2 (if U2 is not identified on the UCI, only the call is possible),
the interaction service initiates the actions linked to U2 (parameterizing the UCI) or a simple call from u1 (because this service knows the number of the subscribed requestor) to u2 if U2 is not known.

What is described above is true for all types of messages that can be sent from a world VW1 to the real world or from a world VW1 to a world VW2 or inside the same virtual world VW1.

4/ billboard on mobile service: this consists of offering an infrastructure that allows advertisers to publish information on a dedicated page. The concept of this advertising service is based on that of an advertising message that appears in the user space from time to time, this message preferably comprising information linked to the user's profile.

For utilizing this advertising service:
the user has an “adverts” space that permanently resides on his or her telephone (depending on the subscription he or she has, he or she is invited to consult this space more or less).
when a service is requested by the user, the platform supporting the advertising service determines whether there is an advertising element that is related to his or her request.
if the platform finds at least one related advertising element, the advertising space is enriched by at least one new advert and the user is informed of this.

Dedicated to advertisers, this space is filled according to complex algorithms including the target the advertiser wants to reach and the number of times it is to be published. This space can also be used to send targeted messages, for example, advertising information that the user has accepted to receive, on various media.

5/ “Digital DNA” service: this concerns modeling an individual through a chain of binary data. This service utilizes a suite of binary properties that can represent any individual, what he or she both is and likes. This universal and public description of the “digital genome” can be used for effective “pattern matching” between individuals.

6/ “Push to Get” service: this consists of offering a prompting on mobile type of communications infrastructure, which can be interactive. The mobile is subscribed to a flow of immediate messages that scroll according to the news items produced by an authenticated service (for example, “AFP”, “auféminin.com”, “Auto/moto”, registered trademarks). The user can request more information by pressing a specific key of the mobile when the message is displayed. In response the server takes into account the message that was the subject of the request and builds a file that is sent to the user on the medium he or she has chosen (electronic mail, voice, services that are the subjects of this invention).

7/ Tamagoshi service (registered trademark): this allows virtual living objects (animals or other) to be created and animated alone or in a community via its service(s). Objects/classes utilized on the server side manage the virtual animal's behaviors. The user can derive these classes and create other virtual animals or worlds. It is noted that exchanges between the server and the mobiles are managed by the server. Each element constituting the animation of the Tamagoshi's life is matched to a telephone key, by means of an icon.

8/ match service: this connects two teams, with rules for passing a ball from one user to the other and conditions for intercepting and shooting.

9/ collaborative service: the infrastructure of the services that are the subjects of this invention enables collaborative services to be developed, defined as services requiring possibilities for several users to interact and share. It is noted that standard services for reading shared information, which several users can access from their mobile, in read-only mode, are not considered collaborative. In collaborative terms, the new service offered consists of utilizing all the following elements:
a distributed application having:
   a centralizing portion residing on the Internet; this is the server portion,
   several distributed portions on mobile terminals—the mobile client portions accessing the server portion via the GML protocol,
   accesses via web browsers, on thin client portions, on PC,
   interactions between the server portion and other applications residing on other web servers, using API or web services on the Internet,
   the possibility given to the mobile portions of supplying information (data, requests) to the server portion and the other mobile portions, via the server portion, and
   the possibility given to the client portions of accessing and modifying at the same time shared data managed by the server portion.

In this service that is the subject of this invention, a dedicated application that allows the sharing and the transactions is present in the mobile portions.

On this principle, several collaborative services are offered by the system including “Glog”, an extension of the blog concept for mobiles. Glog is a shared database residing on and managed by the server portion. This database allows an ordered access to the data submitted to it. The data submitted to Glog are any object that can be generated and sent by a mobile (text, photo, sound, video, voice message, data structured by GML such as social signal, identification of a service and action choices in this service, etc). The data stored by Glog are sorted using several criteria:
discussion thread,
topic,
date/time and
origin.

A discussion thread is a linear order based on the response concept: a thread has a start then simple navigation by next/previous (in read mode), and a response to a thread simply adds an element at the end of the thread, thus increasing its size. A selected Glog thread can be accessed in read mode by a mobile via a service that is the subject of this invention: the last elements, a maximum of nine, are accessible via a dedicated service page then “displayed” on request according to their format (text, sound, image, etc). The person accessing a thread can then add an element (response). The threads are heterogeneous and can contain all types of elements.

The topic is a metadata selected by the creator of a thread. The topic allows the readers of threads to perform targeted searches. As Glog is, like all services that are the subject of this invention, designed for ubiquity of web-mobile access, the topic can be chosen freely during creation if the creation (initialization of a thread) is done from the web site. If the creation is done from a mobile, the creator can either also freely choose a topic by entering a text, or select one topic from nine on a dedicated page. The nine topics shown are either the nine topics that the user has chosen on his or her profile, via the web (general philosophy of preparing his or her own mobile space via the web which, once mobile, is no longer as comprehensive as the web, but is targeted for his or her own pertinent and quick use), or the nine topics used most on Glog, as calculated by the system and proposed to the user. On accessing an existing thread, the reader can also select a topic via this same topic selection window, or select via the window indicating the nine most active topics, or else via his or her window subscribing to his or her nine favorite topics, which he or she can define on his or her glogger profile, via the web.

The “Date and time” field allows a chronological organization, on the one hand, and also, via a web access, time-based searches (whereas the mobile access will by default give the last nine entries in each thread).

The “origin” is the identity of the user who initialized the thread, and also, for each entry in the thread, the identity of the contributor. The glog's server portion also uses this field to calculate, and offer via a web access, activity statistics by glog or by user.

It is noted that the glog can be used in combination with the “gVote” service which allows, generically, each user to assign a status (from a maximum of nine pre-defined statuses) to each candidate (from a maximum of nine pre-defined candidates for each instance of the gVote service). A typical gVote instance could be assigning a rating to an object (service, photo, discussion thread, event, etc). In combination with Glog, gVote therefore allows users to rate the discussion threads, topics, contributions and contributors. The mobile portion of gVote therefore allows a rating to be given and the current result to be displayed, while the server portion, accessed via the web, allows a great richness of historical and statistical results to be displayed, thus enriching Glog.

10/ another collaborative service is the shared alarm service. This is an element of a set of services centered on the organization of time in a group of people; this element comprises, among others, a shared agenda, offered by a third-party web application, and towards which the server portion carries out mediation, thus allowing mobile users to access a shared agenda, for both reading and writing. The alarm service comes into this category. It comprises two structural differences from the agenda: firstly, it is entirely managed by the system and does not require mediation to a third-party service and, secondly, it requires the processing of events in the mobile portions.

The group alarm service operates as follows:
a user uses his or her mobile or web interface to select the date and time of an alarm and its audience. He or she can also select the media used by the system to notify the audience of the alarm, when it is triggered. Except for such a specific selection (e-mail, automatic voice server call, etc), the system will operate in two steps:
the “alarm” service's server, when a group alarm request is received, adds a corresponding element in the events mailbox of each member of the recipient group who is a user of services that are the subjects of this invention;
when these users go to update their events, by the generic mechanism managing and notifying of service events, GML sends to their respective mobile portion a message setting their local alarm. These users are then warned of the triggering of the alarm “locally” by their mobile. The advantage of this remote setting (in contrast to the notifying of the alarm remotely) is that the recipients' alarms are triggered even if they are not receiving the service when the alarm time is reached and
for recipients who are not users of the services that are the subjects of this invention, or for recipients who may not have synchronized their events manager before the alarm time, the alarm service's server portion sends a message via a channel selected by the user who organized this alarm; typically an SMS. A group alarm organized in this way therefore comprises a date and time, an audience, and also a “topic”, which can be free text or one topic out of nine that can be selected via a dedicated selection window. Like all services that are the subject of this invention, these nine topics are either the user's favorite topics defined in his or her profile for this service, via the web, or, by default, the nine most probable topics calculated and proposed by the system based on this service's usage profiles.

It is noted, with respect to the service managing events for services that are the subjects of this invention, that several cases of using this system require a user to be notified when an event concerns them. The system's server not having the capability of spontaneously sending a request to a mobile client user, it cannot itself notify the user of the event that concerns them. The following generic mechanism is therefore used:
firstly, for each user there is in the server a space in which the events relating to this user are stored, according to the time they arrived and their priorities (these events can have varied and heterogeneous sources, such as an autonomous service requiring information or a notification to be sent to a user, or a collaborative service through which another user wants to interact with this user, or a request from a third-party service for which the system carries out mediation to the mobile users). This “events” space is replicated on the mobile during the synchronization operation: the mobile portion automatically enquires about the status of the events space. The events space is itself organized according to the tree-structure having, for preference, a maximum of nine branches on each node.
then the mobile portion—or the user him- or herself for notifications not coming from automatic operations—can process these events as required. The mobile portion will enquire about the possible need to synchronize the event list each time that access to the web server is required; synchronization is therefore frequent. In addition, an additional “polling”, parameterizable by the user, provides a regular synchronization ensuring that events do not become too obsolete, even in cases of prolonged periods in which the mobile portion has no access to the server.

And, finally, for top priority events, an SMS (or other medium chosen by the user, such as a synthesized voice call or electronic mail) is sent to the user, in the case in which the priority event is imminent or where the last synchronization took place a long time ago.

11/ reverse Messagery service: in this new electronic messagery processing mode there is only one instance of the message, which is stored on the issuer's server. The message's recipients read the message on the issuer's server.

This mode of processing is especially suited to messages between identified correspondents in the same organization or community group. When a message is sent from an issuer E to recipients Dn, the recipients are notified that E has sent them a message. Each recipient Dn can therefore connect to E's server with his or her identifier (secured) and as a result read all the messages that E has sent to Dn. If E has sent several messages to Dn, then Dn will see the list of messages that E has sent to him or her (new and old).

If E wants to send a message to a recipient D with whom he or she has not established a relationship of trust, the server sends an e-mail according to the standard method to ask the recipient whether he or she accepts the set up a relationship of trust with E. If the recipient accepts, he or she is connected to E and vice versa.

This new messagery approach makes it possible:
to reduce the use of memory space on messagery servers;
because of this, to delete unwanted messages, or “spam”, since in order to send a message to a recipient the latter must have established a relationship of trust. In the establishment of a relationship of trust, there is no possibility of passing on any message or attachment whatsoever.
for the issuer to know whether the message has been read by one or all of the recipients,
to manage a new concept of a message sent only to the first ones (defined by a number pre-defined by the issuer of the message) who read it: an issuer can send a message to N recipients mentioning that once at least a number X of recipients have read the messages, the other people will not be notified that they have a message to read,
to manage validity dates on a message,
to better discover an internal or external messagery problem since if the message is not read by one or more recipients there is a potential problem.
to limit the visibility of certain parts of a single message according to the category of the recipients (limited distribution list management),
to limit the distribution/proliferation of a message by not allowing it to be downloaded locally onto the recipient work station. If E does not want the message to be diffused or downloaded by the recipient or recipients, he or she uses an encryption option that will only allow screen dump for copying the content and
to remove or edit an issued message.

The reverse messagery approach is suited to the concept of diffusion over several heterogeneous channels. The issuer's server can support several classes of readers:
specific applications (reader on a computer or mobile),
use of a standard message server and
Web application (which can be used from a navigator on a PC or telephone).

12/ This invention also concerns the concept of “complementary widgets”. That is to say that proposed services contain the notion of “Yin” and “Yang” applications: two complementary services mean that a complete service can be proposed (this is the case for the social signal, for example, or the restaurant reservation service described above).

13/ Social signal service: the complementary services “Social Picker” and “Social Reader” aim to offer the “social presence” function. “Social Picker” allows users to say where they are, what they are doing, who they are with, how they are feeling, etc, via the portal of the services that are the subjects of this invention. “Social Reader” is a means of aggregating all these flows. Each user defines who is a member of their community, and he or she follows the updates to these members' statuses.

With respect to configuration, “Social Picker” is a service adjustable by the user: they choose, on the corresponding portal, what type of information and the category they wish to update and communicate when they are in a mobility situation. They can choose one or more categories (“what”, “how”, “where”, etc). A related category also allows them to enter a personalized text directly.

After selecting the categories he or she wants for the “Social Picker”, the user can configure this category by adding 1 to x actions, represented by an image (to be selected from the bank of proposed actions or by uploading a personalized image).

Configuring the Social Reader is relatively simple: it just involves selecting the friends whose statuses will be visible and updated automatically.

With respect to use: to update his or her status, the user just has to “pick”, or select, in the “social picker” the new elements that describe him or her. The user can therefore choose one or more categories to be updated. To update, he or she just needs to select the icon for the action. When he or she has finished updating the category or categories have been updated, he or she can confirm them and the information will then be sent.

This information is updated and can be viewed in two different ways:
by going to a user's “social picker”
by opening the “social reader”, which then displays the x latest updates of friends' profiles.

In addition, this application can interface with other types of web service since the status information can be formatted (sentence format, for example) and sent to third-party services (“twitter”). Through the principle of “picking information”, this is therefore a very innovative way to update external “microblogging” tools available.

14/ les “Notes” and “Images” services are part of the range of “office” services that allow content to be displayed on the mobile. Thanks to the architecture of the system implementing this invention, the ubiquity between the web and the mobile is used by these services. The content can therefore be modified at leisure on the web, and it is updated automatically on the mobile telephone. Thanks to these technical elements of instantaneity of services, there can be many uses (real-time updates to the shopping list by the person who stayed at home, collaborative work between one person on the move and another person in front of a computer connected to the web, etc).

15/ the “To-do-list” service is part of the category of “office” services. It provides the possibility of managing a list of tasks. Each task is represented by a cell of the matrix and has several parameters: deadline, category, title, person, etc, and finally a button for marking the task as completed or not.

15/ the “Agenda” service is also part of the category of “office” services for mobile. It allows the user to monitor events and is interfaced with other services that can come and insert information in it, etc. Thanks to the architecture of the system implementing this invention, these services can be directly accessible via the agenda. The “Agenda” service can import and export information via lcal, etc, types of standards of use.

17/ the “Vote” service allows the user to create a vote, or election, procedure, and promote it to his or her friends in order to have their opinion on a topic. On the portal, the user just needs to select the question and the responses (and the associated icon-images) and the vote service is created automatically. The user then needs to define the audience for the vote or, if it is public, simply promote it among his or her friends. The users who display the “vote” service on the mobile can vote just by selecting the response.

Additional possibilities are offered on the portal with respect to the results and statistics of the vote: the user can monitor the changes in score over time, know how many people voted, etc.

Users can therefore, very easily, carry out real surveys and obtain valuable information about their friends, their customers, etc.

18/ the “MCQ” service (acronym for “multiple-choice questionnaire”) is an extension of the “Vote” service since it consists of putting any number of questions after this “Vote” service. Unlike the “Vote” service, however, the results will not be displayed on the mobile and will only be available on the web (and only for the creator of the multiple-choice questionnaire).

In the same way as the “Vote” service, advanced tools on the web portal enable the administration of the MCQ service and the collection and interpretation of the results. Thanks to the architecture of the system implementing this invention, the users can therefore, in a few moments, create surveys for mobiles that give them a very interesting and instantaneous means of collecting information.

19/ the “Party Planner” service is a service that aims to make organizing events in a community easier. It is a file that allows events to be created or viewed. For each event, this includes:
the choice of the name,
the choice of an audience (people authorized to see and act regarding the event),
votes on the date, place, time. These are initial proposals by the event's initiator, but he or she may decide to accept the new proposals or not.
a list of tasks (things to do, things to contribute, etc). The audience can add elements or mark them as completed.
a page of information,
the integration of a “conference call” service (described above) and
a page of comments, for keeping track of the changes.

This service is the first one that allows users in situations of mobility to organize themselves without needing to make “round-trip” telephone calls. This is the first time that a “management” tool, for managing projects, is proposed to mobile users. More advanced administration and statistics tools are proposed on the portal.

20/ the “shared To-Do List” service is the first service of the range of collaborative services for project management, office, etc uses. The shared to-do list is a “to-do list” that can be modified by a group of people. This allows them to organize themselves remotely when there is a set of tasks to be done, etc. By means of this service the people can then know who must do what, and above all who has done what.

21/ the “Ask the community” service is a service of mutual assistance through questions/responses between the users. When the user is on a business trip, in a situation of mobility, he or she may have a sudden need for information but does not have access to the internet to search for it and find it. By means of the service, he or she has not anticipated this need and therefore has not placed the appropriate service in his or her services space, and cannot remember the service of a friend that might satisfy this need (and perhaps there are still no services associated to this need). Thanks to the “Ask the community” service, he or she can send a question to the community and the community can undertake to find the response, then the person will either have the response directly or a web access that will enable him or her to search the Internet. In other terms, this service responds to the user's question: “I am in a mobility situation and I need information, but I haven't anticipated this so it isn't in my services space (yet)”. Thanks to the “Ask the community” service, people can find the information for this user.

To encourage people to respond, community tools are implemented to promote the best profiles, but the basis is that it is micro-communities that respond. With respect to configuration on the mobile, using the service consists of opening a new question, which is entered using the telephone's keypad and then sent to the system. Several questions can therefore be “open” at the same time. On the other side, the community (or a micro-community) can be activated to respond to the question. The people (who have chosen who they wish to receive requests and questions from) have several means of receiving and responding to questions from the “ask the community” service: via the web portal, a desktop widget, e-mail, instant message service, or via a response service. Each time, the technical solution makes it possible to read the question and respond to it. When the user has received the right response, he or she can “close” the question and archive it, which can also be viewed by the community, to avoid having latecomers responding, for example.

The system implementing this invention is the first tool that puts an isolated person into contact with a connected community. The environment keeps track of these requests and can therefore propose creating services based on the actual requests of users. The services created in this way by the person, the community or directly by specialized developers therefore have a strong chance of responding to a real need, and pleasing users very much. The system can also search to see whether the question has already been asked and if there is a response.

22/ the “Sudoku” (registered trademark) service concerns a game well known to the general public. This service sends a 9×9 matrix and the user can then fill it in at leisure, in several goes, etc, with no web access. It is only when the user chooses “send” that the information is sent for checking, etc.

23/ the “Poker” service utilizes the collaborative capabilities of the system implementing this invention. Thanks to these capabilities, it is possible to have asynchronous poker games. That is to say that the game only continues when all the participants have made their move. A “log” allows these moves to be followed.

24/ the “Inbox” service corresponds to an “Inbox” file combining two types of elements:
firstly, the services that have been sent and proposed by the community (community of friends, subscriptions to services, directly by the system, etc) and
secondly, all the “event logs” of the services. This “inbox” therefore enables all the elements to the received.

25/ the transactional application services responding to very well-known user requests: horoscope, television program, movie theater program, RSS flows, etc. Thanks to the architecture of the system implementing this invention, which allows the users of the service to be segmented and profiled, it is possible to propose the content that will please the user or, at the very least, matches him or her. Through a system of filters, only the content that the user is likely to need is proposed. Movie theater or television programs can therefore be configured on the web portal by the user but they will then be proposed dynamically, based on defined criteria and according to detected similarities.

1-20. (canceled)

21. A method for creating computer applications, that comprises:
a step of receiving a message that has a content,
a step of determining a type of computer application likely to be associated to said content and
a step of parameterizing a generic application of the application type determined with said content to constitute said computer application.

22. A method according to claim 21, wherein, during the step determining a type of computer application, the type of computer application depends on the identity of the sender of said message.

23. A method according to claim 21, wherein, during the step determining a type of computer application, the type of computer application depends on at least one attachment of said message.

24. A method according to claim 21, wherein, during the step determining a type of computer application, the type of computer application depends on key words included in the content of said message.

25. A method according to claim 21, that comprises, in addition, a step of matching applications with a tree-structure, at least two said applications coming from the web, and in an iterative way:
a step of displaying, on a communicating mobile terminal's screen, representations of nodes or descendant leaves of the same node or the root of the tree-structure,
a step of selecting, on said mobile terminal, one of said displayed representations,
a step of communicating, by the mobile terminal to the server, an indication of the node or leaf corresponding to the representation selected,
if a node had been selected, a step of supplying, by the server to the mobile terminal, identifiers of the nodes or descendant leaves of the node selected and an iteration of the selection, communication and supply steps and
if an application from the web is selected, a step of initiating this application.

26. A method according to claim 25, wherein at least one said application is such that, once initiated, at least one new iteration is carried out.

27. A method according to claim 25, wherein, during the matching step, page hypertext links are matched with nodes of the tree-structure.

28. A method according to claim 25, wherein, during the matching step, contents of pages are matched with leaves of the tree-structure.

29. A method according to claim 25, that comprises a step of accessing the server from a second terminal, a step of displaying, on a portion of the page displayed on said second terminal's screen, representations such as they would appear during iterations, on a screen of the mobile terminal.

30. A method according to claim 21, that comprises, in a routing server:
a step of receiving data to be transmitted, said data being associated to an identifier of the recipient,
a step of determining a context for transmitting data to the recipient,
a step of selecting at least one reception channel associated to said recipient according to said context and a step of transmitting data on each reception channel selected.

31. A method according to claim 21, that comprises:
a step of initiating the communication, by a first user,
a step of selecting, by said first user, at least two users known as “second users”,
a step of notifying, by a server, each second user selected, during which each second user receives information from a graphical interface representing the first user and each other second user selected,
when the communication is accepted by a second user, a step of connecting the first user and each second user having accepted the communication.

32. A method according to claim 21, that comprises, in order to transform a web page for displaying on a communicating mobile terminal:
a step of receiving a web page comprising an HTML content and Javascript,
a step of pre-analyzing, by a gateway server, characteristics of the formatting of said page's HTML content,
a step of transforming the HTML content and its formatting into a compact binary form, on the gateway server,
a step of compiling, on the gateway server, said page's Javascript into instructions directly executable by the communicating mobile terminal and
a step of supplying said communicating mobile terminal with the compact binary form of the HTML content and instructions.

33. A method according to claim 32, wherein, during the compilation step, the page's Javascript is compiled into “bytecode” instructions directly executable by the communicating mobile terminal.

34. A method according to claim 32, that comprises, in addition, a step of associating Javascript code contained in the page and at least one native function of the mobile telephony part of the communicating mobile terminal.

35. A method according to claim 32, wherein, during the step of transformation into a binary format, a step is carried out expanding styles of the page's HTML content defining the appearance of elements of the page's HTML content.

36. A method according to claim 35, wherein said styles are CSS styles (acronym for Cascading Style Sheets).

37. A method according to claim 21, that comprises, during a step of receiving a web page:
a step of extracting at least one hypertext link from the content of the page and
a step of displaying each link extracted from the content of the page.

38. A method according to claim 37, wherein, during the display step, at least one extracted link is associated with a graphic representation and said graphic representation is displayed on a screen.

39. A device for creating computer applications, that comprises:
a means of receiving a message that has a content,
a means of determining a type of computer application likely to be associated to said content and
a means of parameterizing a generic application of the application type determined with said content to constitute said computer application.

40. A computer program, that comprises instructions that can be executed by a computer in order to implement a method according to claim 21.
